(19) United States
(12) Patent Application Publication
(10) Pub. No.: US 2026/0098777 A1
(43) Pub. Date: Apr. 9, 2026

(54) Computing Ecosystem for Aircraft Operations

(71) Applicant: Joby Aero, Inc., Santa Cruz, CA (US)

(72) Inventors: Shaun Michael Giudici Bhargav, San Jose, CA (US); Christabelle Simone Juliette Bosson, Mountain View, CA (US); Satish Kumar Chilakala, San Ramon, CA (US); Matthew David Schwegler, San Francisco, CA (US)

(21) Appl. No.: 19/349,439

(22) Filed: Oct. 3, 2025

Related U.S. Application Data
(60) Provisional application No. 63/703,620, filed on Oct. 4, 2024.

(51) Int. Cl. G01M 1/12; G07C 5/00

(52) U.S. Cl. CPC G01M 1/125; G07C 5/008

(57) ABSTRACT

A system includes a network computing system and a user computing device. The network computing system includes a plurality of software services associated with aircraft operations. The user computing device is operable to connect to the network computing system, over a network, to access data from one or more software services of the plurality of software services. The user computing device is operable to automatically perform one or more pre-flight computing functions for an aircraft based on the data from the one or more software services of the network computing system. At least one of the pre-flight computing functions includes an automatic weight and balance computation for a payload of the aircraft based on the data accessed from the one or more software services of the network computing system.

### RELATED APPLICATIONS

The present application claims the benefit of and the priority to U.S. Provisional Patent Application No. 63/703,620 , filed Oct. 4, 2024, which is hereby incorporated by reference in its entirety.

### FIELD

The present disclosure relates generally to distributed computing hardware for performing aircraft computing operations. For example, a network computing system can implement a software service architecture that allows a client device to function as an electronic interface for performing aircraft operations and establish a secure communication channel with the aircraft.

### BACKGROUND

Transportation service applications allow individual users to request transportation. For example, service providers can match drivers/vehicles to requests for transporting a rider to a requested destination. Computing platforms can be used to help facilitate these services.

### SUMMARY

Aspects and advantages of implementations of the present disclosure will be set forth in part in the following description, or may be learned from the description, or may be learned through practice of the implementations.

An example aspect of the present disclosure is directed to a system. The system includes a network computing system including a plurality of software services associated with aircraft operations. The system includes a user computing device operable to connect to the network computing system, over a network, to access data from one or more software services of the plurality of software services. The user computing device is operable to automatically perform one or more pre-flight computing functions for an aircraft based on the data from the one or more software services of the network computing system. At least one of the pre-flight computing functions includes an automatic weight and balance computation for a payload of the aircraft based on the data accessed from the one or more software services of the network computing system.

In an example, the data from the one or more software services includes aircraft data and payload data. The aircraft data is indicative of: (i) a seat and cargo configuration of the aircraft, and (ii) a payload capacity of the aircraft. The payload includes a plurality of individual payload items. The payload data is indicative of at least one of: (i) a weight for each respective payload item or (ii) dimensions for each respective payload item.

In an example, to perform the automatic weight and balance computation for the payload of the aircraft, the user computing device is operable to process the aircraft data and the payload data to compute a payload configuration. The payload configuration defines a position of each respective payload item within the seat and cargo configuration of the aircraft based on: the payload capacity of the aircraft, and at least one of the weight or the dimensions for each respective payload item. The user computing device is operable to output data indicative of the payload configuration for presentation via a user interface of the user device.

In an example, to compute the payload configuration, the user computing device is operable to process the seat and cargo configuration and the payload data to iteratively compute candidate payload configurations. The user computing device is operable to compute a selected payload configuration from the candidate payload configurations, the selected payload configuration being within weight and balance constraints of the aircraft.

In an example, the aircraft data is indicative of: a charge level of the aircraft. The payload configuration is further based on the charge level of the aircraft.

In an example, the user computing device is operable to transmit, over the network, the data indicative of the payload configuration to the network computing system.

In an example, the system includes an aircraft computing system of the aircraft. The user computing device is operable to connect with the aircraft computing system of the aircraft.

In an example, the user computing device is operable to access data indicative of an aircraft identifier from the network computing system and connect with the aircraft computing system based on the aircraft identifier.

In an example, to connect with the network computing system, the user computing device is operable to establish a first communication channel with the network computing system. To connect with the aircraft computing system, the user computing device is operable to establish a second communication channel with the aircraft computing system that is separate from the first communication channel.

In an example, the second communication channel between the user computing device and the aircraft computing system is maintained while the aircraft is in-flight from an origin to a destination. The first communication channel is disconnected for at least a time period while the aircraft is in-flight from the origin to the destination and the first communication channel is reestablished when the aircraft lands at the destination.

In an example, the user computing device is operable to transmit an updated data package to the network computing system after the first communication channel is reestablished, the updated data package including at least one of: (i) pilot flight time data, or (ii) aircraft performance data.

In an example, the user computing device is operable to automatically perform one or more post-flight computing functions for the aircraft.

In an example, the network computing system includes a micro-service architecture, and the plurality of software services include a plurality of micro-services.

In an example, the plurality of software services includes at least one of: (i) a pilot software service, (ii) an aircraft software service, (iii) a passenger software service, (iv) an aerial facility software service, (v) a flight operations software service, or (vi) an aircraft maintenance software service.

In an example, the user computing device includes a software application. The software application includes a login interface for a pilot of the aircraft. The user computing device is operable to perform a handshake with the network computing system to establish a communication channel between the network computing system and the user device.

Another example aspect of the present disclosure is directed to a user device that includes one or more processors and one or more memories that store instructions that are executable by the one or more processors to perform operations. The operations: include launching a software application; accessing, via the software applications, credentials from a pilot; establishing a first communication channel with a network computing system based on the credentials, wherein the network computing system includes a plurality of software services associated with aircraft operations; accessing, over the first communication channel, data from one or more software services of the network system; performing one or more pre-flight computing functions based on the data from the one or more software services of the network computing system. At least one of the pre-flight computing functions includes an automatic weight and balance computation for a payload of an aircraft based on the data accessed from the one or more software services of the network computing system.

In an example, the operations further include: establishing a second communication channel with an aircraft computing system; accessing, over the second communication channel and from the aircraft computing system, aircraft data associated the aircraft; and based on the aircraft data, performing one or more computing functions associated with the aircraft. The computing functions include at least one of: one or more of the pre-flight computing functions, one or more computing functions during a flight, or one or more post-flight computing functions.

In an example, accessing the data from the one or more software services of the network computing system includes: accessing an API associated with the network computing system; computing a request for the data from the one or more software services based on the API, the request including one or more queries for the data from the one or more software services; and transmitting, over the first communication channel, the request for the data from the one or more software services.

In an example, the plurality of software services includes at least one of: (i) a pilot software service, (ii) an aircraft software service, (iii) a passenger software service, (iv) an aerial facility software service, (v) a flight operations software service, or (vi) an aircraft maintenance software service.

Another example aspect of the present disclosure is directed to a computer-implemented method including: launching a software application; accessing, via the software applications, credentials from a pilot; establishing a first communication channel with a network computing system based on the credentials, wherein the network computing system includes a plurality of software services associated with aircraft operations; accessing, over the first communication channel, data from one or more software services of the network system; performing one or more computing functions for an aircraft based on the data from the one or more software services of the network computing system. At least one of the pre-flight computing functions includes an automatic weight and balance computation for a payload of the aircraft based on the data accessed from the one or more software services of the network computing system.

In an example, the method further includes: establishing a second communication channel with an aircraft computing system, wherein the second communication channel is different from the first communication channel, wherein the second communication channel remains connected while the aircraft is inflight.

In an example, the method further includes: while the aircraft is inflight, accessing, over the second communication channel and from the aircraft computing system, aircraft data associated with the aircraft.

In an example, the first communication channel is temporarily disconnected and the method further includes: after landing of the aircraft, re-establishing the first communication channel between the user computing device and the network computing system; generating a data package for the network computing system based on the aircraft data accessed over the second communication channel while the aircraft is inflight; and transmitting, over the first communication channel, the data package to the network computing system.

In an example, the aircraft is a VTOL aircraft, and wherein performing the one or more computing functions includes accessing data indicative of a weight and balance constraint for the VTOL aircraft and performing the automatic weight and balance computation to compute a payload configuration for the VTOL aircraft based on the weight and balance constraints for the VTOL aircraft.

Another example aspect of the present disclosure is directed to a non-transitory computer-readable media including any of the foregoing.

Other example aspects of the present disclosure are directed to other systems, methods, vehicles, apparatuses, tangible non-transitory computer-readable media, and devices.

These and other features, aspects and advantages of various implementations will become better understood with reference to the following description and appended claims. The accompanying drawings, which are incorporated in and constitute a part of this specification, illustrate implementations of the present disclosure and, together with the description, serve to explain the related principles.

### BRIEF DESCRIPTION OF THE DRAWINGS

Detailed discussion of implementations directed to one of ordinary skill in the art are set forth in the specification, which makes reference to the appended figures, in which:

FIG. 1 depicts an example computing ecosystem according to example implementations of the present disclosure;

FIG. 2 depicts an example software service architecture according to example implementations of the present disclosure;

FIGS. 3A-B depict data structures of software services according to example implementations of the present disclosure;

FIGS. 4A-B depict example dataflows according to example implementations of the present disclosure;

FIGS. 5A-B depict example user interfaces according to example implementations of the present disclosure;

FIGS. 6A-B depict example user interfaces according to example implementations of the present disclosure;

FIGS. 7A-C depict example user interfaces according to example implementations of the present disclosure;

FIGS. 8A-D depict example user interfaces according to example implementations of the present disclosure;

FIGS. 9A-C depict flowchart diagrams of example methods according to example implementations of the present disclosure;

FIG. 10 depicts an example transportation service according to example implementations of the present disclosure; and

FIG. 11 depicts a block diagram of an example computing system according to example embodiments of the present disclosure.

### DETAILED DESCRIPTION

Generally, the present disclosure is directed to a computing ecosystem that intelligently aggregates real-time data and automates complex computing functions for aircraft operations. For example, prior to take-off, a pilot can be responsible for performing tasks of a pre-flight checklist. These tasks can include status checks of various aircraft components and parameters such as fuel level, visibility, etc. The pilot may have similar such responsibilities post-flight, including logging pilot flight hours, recording aircraft flight parameters, etc. Although these tasks may be presented visually on a computer, the performance of the tasks remains largely manual and time consuming for the pilot. Moreover, even when the checklists are integrated into a computer, they are merely for visualization and such solutions lack the intelligence and automation of real-time data sources and software services from a network computing system—e.g., particularly one that supports on-demand transportation services. This can lead to computational inefficiency, out-of-date data, and, ultimately, decreased aircraft performance.

The technology of the present disclosure provides a computing ecosystem with a software service architecture and on-device software applications that improve computational efficiency for performing aircraft operations. The ecosystem can include hardware such as a network computing system, a user device, and an aircraft computing system.

The network computing system can be a cloud-based operating system. The network computing system can include a micro-service software architecture, which includes a plurality of micro-services. The micro-services can be accessed by calling an application programming interface (API). Each of the micro-services can be programed to perform a specific function to support various aircraft operations, as well as corresponding on-demand transportation services. For example, the architecture can include micro-services programmed to process information and determine which pilots, aircraft, and aerial facilities are available/eligible for a particular flight. Additional micro-services can be programed to generate passenger itineraries and perform flight operations such as generating a flight schedule, assigning passengers to a particular flight, etc. Such information can be transmitted to the user device for the performance of certain automated functions.

The user device can be a client computing device utilized by a pilot of the aircraft. For example, a pilot may utilize a tablet stored in the aircraft or the pilot's mobile phone. The user device can include a plurality of software applications that are configured to communicate with the micro-services of the network computing system over a network. The pilot can log-in to a software application by providing the pilot's unique digital credentials. Once launched, the software application can initiate a handshake procedure between the user device and the network computing system. This can allow the two systems to establish a secure communication channel, by which the user device can transmit data to and from the micro-services of the network computing system using API calls.

The software applications of the user device can include, for example, a pilot application. The pilot application can be programmed to perform (on the user device) various computations. For example, the pilot application can help manage the pilot's schedule and workflow, record flight hours, and automate pre-and post-flight computations. One example pre-flight computation performed by the pilot application can include an automated weight and balance computation.

To perform the automated weight and balance computation, the user device can access data from the micro-services of the network computing system. For instance, the user device can call an API to format a request for the network system's aircraft micro-service. The request can include a query for the specifications of the aircraft assigned to a given flight on the pilot's schedule. The specifications can indicate the aircraft's payload capacity (e.g., by weight, dimensions), its seating arrangement, cargo storage arrangement, etc. The user device can also utilize the API to format a request for the network system's passenger itinerary micro-service. This request can include a query for the passenger manifest and associated payload weights for the given flight. In response to the requests, the micro-services can compute a data packet and transmit it, over a network, back to the user device.

The pilot application can be programmed to ingest the requested data and automatically compute a weight and balance recommendation for the aircraft. For example, given the respective payloads of the passengers, the pilot application can be programmed to iteratively generate different combinations of seat assignments and cargo storage assignments within the interior arrangement of the aircraft. The pilot application can continue its iterative processing until a specific combination provides a payload configuration that meets the balance constraints of the aircraft. The analysis can also take into account the seating preferences and requests from the individual passengers.

In some implementations, the user device can present its recommended payload configuration to the pilot. For instance, the user device can output data indicative of the various seating assignments and cargo positions. The data can be visually rendered via a user interface on a display of the user device. The user interface can indicate weights, cargo positions, seating assignments, etc. The pilot may interact with the user interface via a touchscreen or cursor, to adjust the payload configuration by changing a seat assignment or cargo position. Once confirmed by the pilot, the user device can access an API to format a data signal that is appropriate for the network computing system. The data signal can indicate the confirmed payload configuration and can be transmitted to the appropriate micro-services (e.g., the aircraft service).

In some implementations, the user device can communicate with the aircraft. For example, the user device can access data indicative of an aircraft identifier from the network computing system (e.g., the flight operations service). Such data can be transmitted from the flight operations service to the pilot application using the first communication channel established between the user device and the network system. The user device can utilize the aircraft identifier to establish a second communication channel with the computing system of the aircraft (the “aircraft computing system”). The second communication channel can be different than the first communication channel. For example, the second communication channel may utilize a near-field or Bluetooth® protocol, whereas the first communication channel may utilize a cellular network. Thus, while the first communication channel may temporarily cease while the aircraft is inflight, the second communication channel between the user device and the aircraft computing system may persist, allowing the user device to continue receiving data from the aircraft during flight.

The aircraft computing system can transmit a variety of data to the user device. For example, prior to take-off, the aircraft computing system can transmit data indicative of the aircraft's current charge level, component health and status, location, etc. During flight, the aircraft computing system can provide updated charge levels, route progress, individual component feedback, altitude, skylane, etc. After landing, the aircraft computing system can transmit similar, updated data in addition to information about the landing (e.g., approach, maneuvers, hover time), overall aircraft flight time, route flown, etc. The user device may compute a data package that is indicative of such information and transmit it to the appropriate micro-services of the network system (e.g., the aircraft service, flight operations service). This can allow the network system to more readily and efficiently access such information from the aircraft computing system in addition, or in alternative to, communicating with a third party service that aggregates such data.

The technology of the present disclosure can provide numerous technical effects and improvements to computing technology. The software service architecture of the network computing system can provide particular flexibility to user devices and aircrafts operating within the ecosystem. For example, the micro-services can be decoupled such that each service is a separate entity that can be developed, deployed, and scaled independently, allowing for greater flexibility in development and maintenance. Each service can also be responsible for a specific functionality or capability, making it easier to understand, develop, and test. Inter-service communication can provide improved efficiency as the software services can communicate with each other using lightweight protocols, such as HTTP/REST, gRPC, or messaging queues. The services can be scaled independently, improving the ability to prioritize development in areas of need, thereby improving resource utilization and system performance. Moreover, the architecture of the network system can improve fault isolation because failures in one microservice do not necessarily impact the entire system, enhancing the overall system's resilience and stability.

The technology of the present disclosure improves the overall reliability and performance of the computing hardware that is operating together to support various aircraft-related functions. For example, as described herein, the user device can asynchronously establish separate communication channels with the network system and the aircraft computing system. This can allow the user device to maintain a communication channel with the aircraft while inflight, despite disruptions in connectivity with the network system. As such, the user device can continue to process and package information from the aircraft during the flight so that it is ready for transmission as soon as the network connection is re-established (e.g., during/after landing). This can provide the network system with another source of aircraft data in addition to any third-party system that compiles data from the aircraft. Moreover, the data from the user device can be formatted and transmitted to the appropriate micro-services without further processing from the network service to transform data from a third party format to a format appropriate for its services. Accordingly, the computing ecosystem of the present disclosure can improve the allocation of the network's processing and, thus, provide more efficient use of its overall computing resources.

### Example Computing Ecosystem

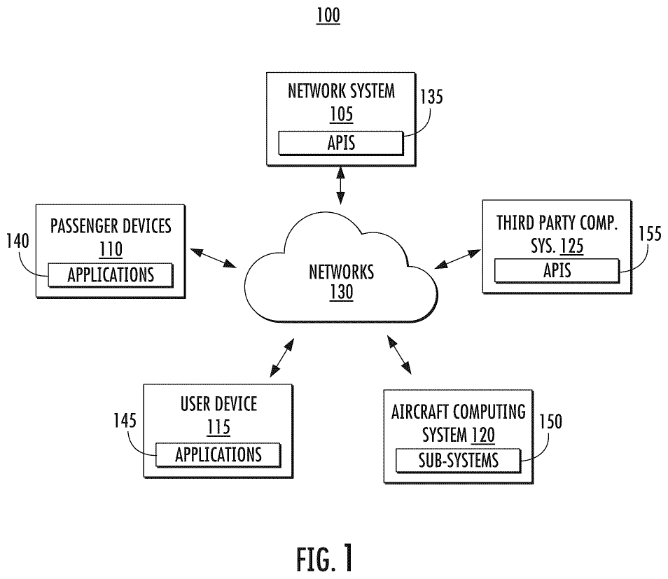

FIG. 1 depicts a block diagram illustrating an example computing ecosystem 100. The ecosystem 100 can include a distributed computing network for coordinating aircraft to provide transportation services. This can include cross-platform coordination for transportation services.

The ecosystem 100 can include a variety of computing hardware. For example, the ecosystem 100 can include a network computing system 105 (or “network system 105”), one or more passenger computing devices 110 (or “passenger devices 110”), a user computing device 115 (or “user device 115”), an aircraft computing system 120 (or “aircraft system 120”), and a third-party computing system 125 (or “3P system 125”).

Each of the systems or devices can communicate over one or more wireless or wired networks 130. The networks 130 can include one or more types of networks including telecommunications networks, internet, private networks, or other networks, as further described herein.

The systems and devices of ecosystem 100 can include a plurality of application programming interfaces (APIs) and software applications operating on the respective systems and devices. This can create an ecosystem of interfaces and applications for performing aircraft operations as well as providing and coordinating transportation services, as further described herein.

The network system 105 can be associated with a service entity that provides at least an aerial transportation service to users. The network system 105 can include a computing platform (e.g., a cloud services platform, server system, etc.) with an operating system. The computing platform can be communicatively connected over the networks 130 to one or more of the systems or devices of ecosystem 100.

The network system 105 can include or implement one or more client-facing software applications accessible to the devices of ecosystem 100. Users can interact with the network system (e.g., using passenger devices 110, user device 115) to receive various types of information. For example, a passenger can interact with the network system 105 via an instance of a software application (e.g., a passenger app) running on the passenger device 110 to request and book a transportation service. In another example, a pilot can interact with the network system 105 via an instance of a software application (e.g., a pilot app) running on a user device 115.

In some implementations, the software application of one system can be run within or accessed by the software application of another system. For example, a user interface of a software application associated with the network system 105 can be embedded within and displayed with the user interface of the software application associated with another system (of a ground transportation service provider), or vice versa. This can allow a user to utilize one application, while accessing another (e.g., for requesting transportation).

The network system 105 can be associated with one or more aircrafts, aircraft operators, aerial facilities (or portions thereof), facility operators, etc., for facilitating the performance of at least an aerial transportation service. For example, the aircraft can include a fleet of aircrafts and the vehicle operators can include a network of aircraft operators. The network of aircraft operators can include pilots or remote operators that facilitate, oversee, or control the movement of aircrafts available to perform aerial transportation services.

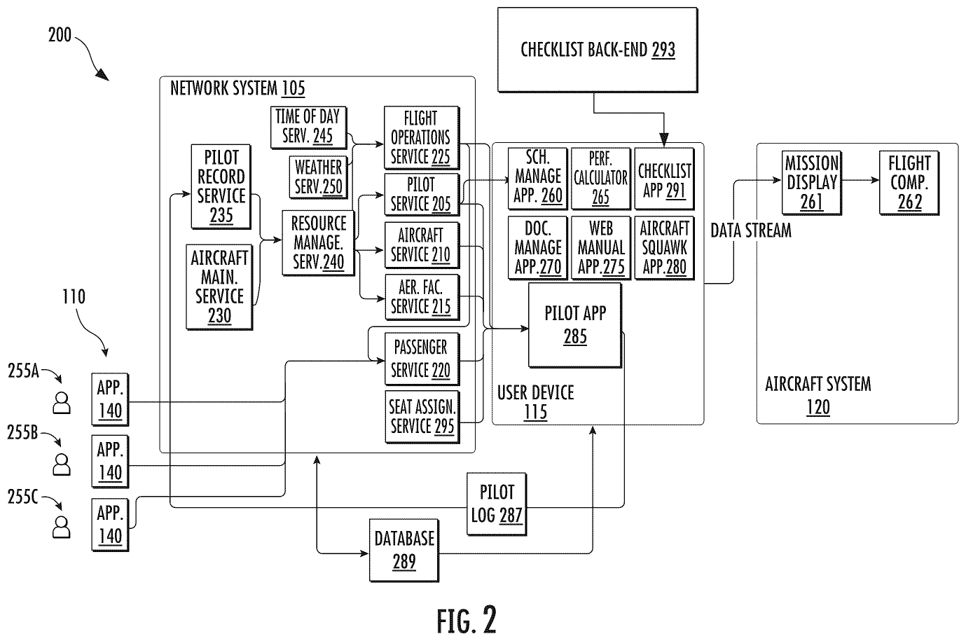

As will be described in greater detail with respect to FIG. 2, the network system 105 can include a software service architecture. The architecture can include a plurality of software services that run on the servers and processors of the network system 105. The software services can be accessed by calling one or more APIs 135. The software service architecture can facilitate the performance of a plurality of different aircraft operations including the coordination of transportation for passengers.

Passenger devices 110 can include computing devices owned or otherwise accessible to a user of a transportation service. For example, a passenger device 110 can include a hand-held computing device (e.g., a phone, a tablet, etc.), a wearable computing device (e.g., smart watch, smart glasses, etc.), personal desktop devices, or other devices. Passenger devices 110 can include personal devices (e.g., a mobile device) or shared devices on which a user has initiated a personal session (e.g., by logging into a public kiosk or display device in a vehicle, etc.).

Passenger devices 110 can execute one or more instructions to run an instance of a software application 140 for a respective transportation platform and present user interfaces associated therewith. A software application 140 may include a software application associated with the network system 105 (and its associated service entity) to request aerial transportation. In some implementations, a software application 140 may include a software application associated with another service entity (e.g., a ground-based ride hailing service) and may be configured to communicate with the network system 105 to coordinate aerial transportation for a passenger directly or through an intermediary system.

The user device 115 can be a client computing device utilized by a pilot of an aircraft. The user device 115 can include a hand-held computing device (e.g., a phone, a tablet, etc.), a wearable computing device (e.g., smart watch, smart glasses, etc.), personal desktop devices, or other devices. For example, a pilot may utilize a personal tablet, their mobile phone, or a tablet stored in the aircraft.

The user device 115 can include a plurality of software applications 145 that are configured to communicate with the software services of the network system 105 over the networks 130. The pilot can log-in to the software applications 145 by providing the pilot's unique digital credentials. Once launched, the software applications 145 can initiate a handshake procedure between the user device 115 and the network system 105. This can allow the user device 115 to establish a secure communication channel with the network system 105. The user device 115 can utilize this channel to transmit data to and from the software services of the network system 105, using the APIs 135.

The aircraft system 120 can include an aircraft's computing system that is located onboard the aircraft. The aircraft can be an airplane, vertical take-off and landing vehicle (“VTOLs”), or other aircraft including conventional take-off and landing vehicles (“CTOLs”). VTOLs, for example, can include one or more different types of rotorcraft (e.g., helicopters, quadcopters, gyrocopters, etc.), tilt-rotor aircraft, powered-lift vehicles, and/or any other vehicle capable of vertically taking-off and/or landing (e.g., without a runway).

The aircraft system 120 can include various subsystems 150 of the aircraft including a pilot interface, an avionics system, an infotainment system, a navigation system, an autonomy system, or any other sensors or devices located on the aircraft and capable of sending or receiving information.

The aircraft system 120 can be configured to communicate data with one or more of the other systems/devices of the ecosystem 100. For example, the user device 115 can be configured to establish a secure communication channel with the aircraft 120, or at least one or more of its subsystems 150. In some implementations, this communication channel can be established using near-field communication, Bluetooth® protocol, ultra-wide band, etc. The aircraft system 120 can also communicate with one or more third-party systems (e.g., via the networks 130, satellite communications) to access certain data for operating the aircraft and to transmit data from the aircraft.

The third party systems 125 can include one or more systems that support aircraft flight. This can include, for example, one or more airspace systems such as airspace data exchanges or systems associated with regulatory bodies configured to collect real-time, historical, or regulatory airspace data. The airspace systems can include, for example: (i) aggregating systems that pool airspace data associated with an airspace and the aircraft operating therein; (ii) third-party monitoring systems configured to monitor aspects of an airspace (e.g., noise, etc.); or (iii) regulatory systems that can confirm, validate, or approve an aerial transportation service before take-off based on one or more policies or standards set by a regulatory body (e.g., Federal Aviation Administration, European Aviation Safety Agency, etc.). The third party systems may include other support systems to which the aircraft reports real-time data via a communication link that remains established during flight. In some implementations, the third party systems 125 can be associated with a weather service that provides weather data associated with an airspace in which the aircraft is, or will be, operating.

The other systems of the ecosystem 100 can communicate with the third party systems 125 via one or more APIs 155. The APIs 155 can provide definitions and libraries for formatting requests to access data from the third party systems 125. For example, the network system 105 may call an API 155 to compute a request for certain data associated with an aircraft operating on its service network.

### Example Computing Architecture

The computing ecosystem 100 can include an architecture that is designed to improve the computational efficiency of the ecosystem when performing tasks for supporting aircraft operations. FIG. 2 depicts an example software service architecture 200 according to example implementations of the present disclosure.

The network system 105 can include a plurality of software services associated with aircraft operations. For example, the network system 105 can include a micro-service software architecture and the plurality of software services can include a plurality of micro-services. The software services can be accessed by calling one or more APIs 135. Each software service can be implemented on separate, discrete computing hardware or shared hardware (e.g., processors, memories). While they may share computing resources where needed, the software services can be decoupled from one another such that each software service is a separate entity that can be developed, deployed, and scaled independently. This decoupling can allow for greater flexibility in development and maintenance. Moreover, the software services can support continuous integration and continuous deployment (CI/CD) practices, enabling frequent updates and releases. This can allow individual services to be scaled independently, improving resource utilization and system performance.

The software services can communicate with one another. For example, a software service can be programmed to access data stored and maintained by one or more other software services to perform the function for which it is programmed, as further described herein. The communication between software services can use lightweight protocols, such as HTTP/REST, gRPC, or messaging queues.

Each of the software services can be programed to perform a specific function to support various aircraft operations, as well as corresponding transportation services. For example, the plurality of software services can include: a pilot software service 205, an aircraft software service 210, an aerial facility software service 215, a passenger software service 220, a flight operations software service 225, an aircraft maintenance software service 230, a pilot records software service 235, a resource manager software service 240, a time of day software service 245, and a weather service 250. These software services are also referred to herein as “services”.

The pilot service 205 can track and store information about a pilot. This can allow the pilot service 205 to compute whether a pilot is eligible for a particular flight. To do so, the pilot service 205 can transmit a message to the pilot record service 235 requesting information for a pilot.

The pilot record service 235 can be programmed to track and maintain up-to-date information regarding a pilot's accrued flight time over a given time period, as well as a pilot's overall total flight time. This information can be updated after each flight via the user device 115, as further described herein. Moreover, the pilot record service 235 can maintain records of pilot certification, history of operating in certain geographies/airspaces, history of operating certain aircrafts, history of performing certain flight services (e.g., cargo transport, passenger transport, charter, commercial), and other information.

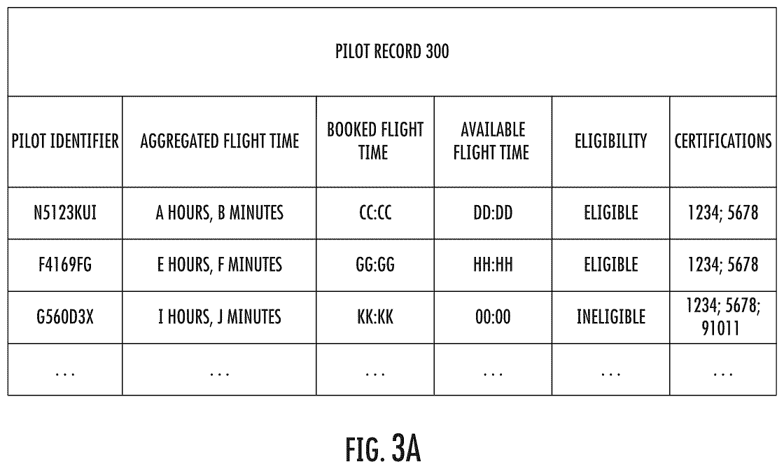

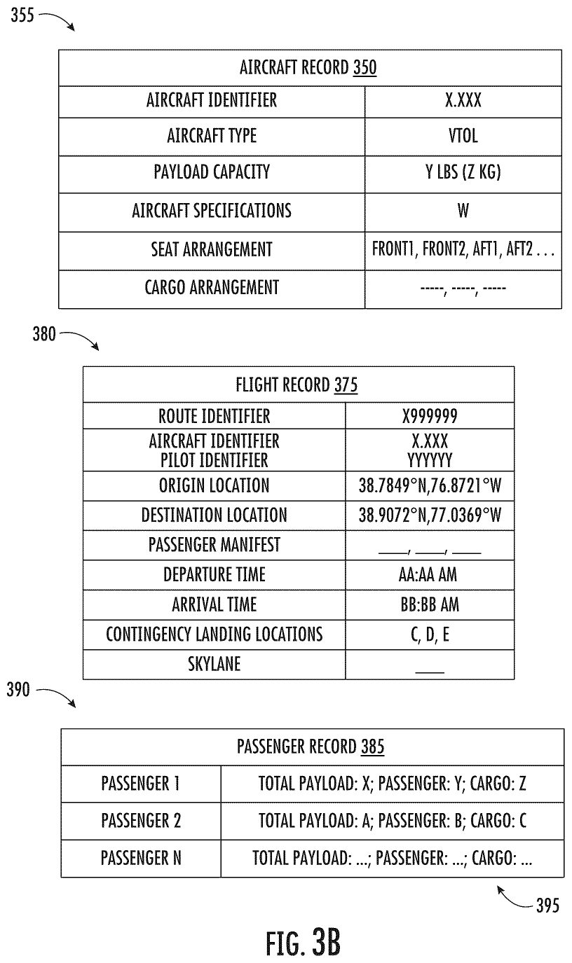

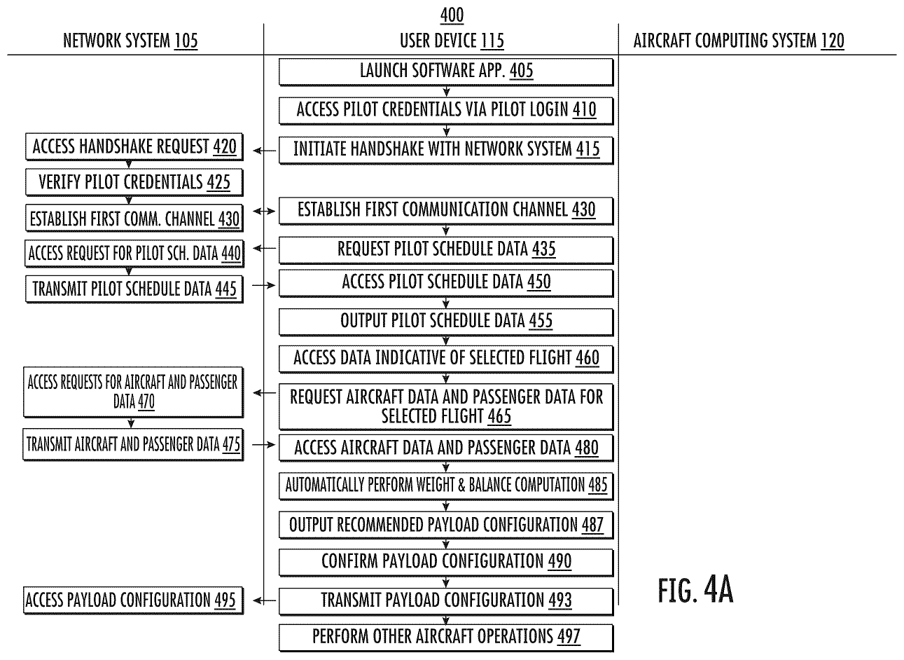

An example pilot record 300 is shown in FIG. 3A. The pilot record 300 can be stored in a data structure. The data structure can include a table, list, array, etc. The data structure can include one or more cells or fields that include data entries. The entries can be written, removed, replaced, revised, etc. to update the information stored in the pilot record.

These records can be updated based on a pilot operating an aircraft as coordinated by the network system. In some implementations, a pilot may submit (e.g., via the user device 115) updated information such as a new certification or flight time on another platform.

In some implementations, the pilot record service 235 may be programmed to access another system that aggregates information about pilots. This may be the system of another service entity.

In some implementations, the pilot service 205 can be programmed to access real-time data from the user device 115. This can allow the pilot service 205 to analyze real-time data for a given day from the user device.

The pilot service 205 can be programmed to process data associated with the pilot to compute whether or not a pilot is eligible for a particular flight. By way of example, the pilot service 205 can process the pilot's certification data and flight time within the relevant time period to determine whether the pilot would be eligible for flying on-demand transportation services on a given day or for a portion of that day.

A pilot can be considered eligible in the event that the pilot has a sufficient amount of available flight time remaining to complete the particular flight. The pilot cannot exceed a flight time threshold, which can be set, for example, by a regulatory body. The pilot's available flight time can equal the flight time threshold minus the summation of the pilot's aggregated flight time and the booked flight time. The pilot's aggregated flight time can represent the amount of time already flown by the pilot. The booked flight time can be the amount of flight time already assigned to the pilot for upcoming flights.

In the event that the pilot is eligible for the given day (or a portion thereof), the pilot service 205 can provide entry in a field/cell of a data structure indicating the pilot's eligibility for the time period in question. As the pilot's flight time continues to increase, the pilot service 205 can adjust the values in the field/cell to indicate the pilot is ineligible for being scheduled to fly. This is shown, for example, in the pilot record 300 of FIG. 3A.

Returning to FIG. 2, the aircraft service 210 can be programmed to aggregate specific information about an aircraft and compute whether the aircraft is eligible for a particular flight. For example, the aircraft service 210 can track flight time for a fleet of aircrafts, while also maintaining real-time data indicating various aircraft parameters (e.g., charge level, component usage/life, temperature). In some implementations, such information can be transmitted to the aircraft service 210 from the user device 115, based on the user device's communication with the aircraft computing system 120.

To help compute an aircraft's eligibility, the aircraft service can communicate with the aircraft maintenance service 230. The aircraft maintenance service 230 can track usage and wear on an aircraft and its components. The aircraft maintenance service 230 can track these parameters based on the age of the aircraft (and its components), operating conditions of the aircraft (e.g., flight duration, weather, speed, altitude), battery age/status/health, flight time, and any other parameters that help determine whether an aircraft should be scheduled for maintenance. The aircraft maintenance service 230 can compute or estimate when the aircraft is to receive maintenance as well as the maintenance schedule for the aircraft.

The aircraft service 210 can be programmed to process data from the aircraft maintenance service 230, along with real-time data from the user device 115, to proactively determine whether an aircraft is eligible for a subsequent flight or whether the aircraft should be taken offline for maintenance, charging, extended cooling, etc. The aircraft service 210 can enter a value or other type of indicator within a field/cell of a data structure to indicate whether the aircraft is eligible or ineligible to perform a flight. This information can be exposed to the flight operations service 225 to support its flight scheduling functions.

In the event the aircraft is eligible, the aircraft service 210 can include one or more flight constraints for the aircraft. This may include, for example, an upper limit on the amount of flight time/distance the aircraft can perform before the aircraft becomes ineligible. Such information can also be exposed to the flight operations service 225.

In some implementations, the aircraft service 210 can maintain records of the aircraft's identifier, type, specifications, and payload capacity. For example, as shown in FIG. 3B, the aircraft service 210 can store an aircraft record 350. The aircraft record 350 can be stored in a data structure. The data structure can include a table, list, array, etc. The data structure can include one or more cells or fields that include data entries. The entries can be written, removed, replaced, revised, etc. to update the information stored in the aircraft record 350.

The aircraft record 350 can include data regarding an aircraft's seat/cargo arrangement. For example, the aircraft record 350 can indicate the specific seat locations within the cabin of the aircraft, the location and weight of the aircraft components, the weight and location of any safety equipment, the location and dimensions of storage positions for cargo, and the general weight distribution of the aircraft's frame/structure. As further described herein, this information can be transmitted over a network 130 to the user device 115 for performing certain computations locally on the user device 115.

The aerial facility service 215 can be programmed to compute the ability of an aerial facility to receive and service an aircraft. An aerial facility can include a skyport, vertiport, or another type of structure that allows for aircraft landing and take-off. The aerial facility can include infrastructure for aircraft servicing. This can include, for example, charging stations to charge aircraft batteries and cooling infrastructure to help with aircraft climate control while the aircraft is at the facility.

Each aerial facility may include different capacity for aircrafts and charging. For example, one aerial facility may have more or less landing pads and chargers than another aerial facility. In another example, a certain aerial facility may have fewer or more expansive operating hours than other aerial facilities. The aerial facility service 215 can maintain records of the facilities'capacity and infrastructure as well as real-time data about their current or scheduled occupancy.

The aerial facility service 215 can maintain records of the facilities'capacity and infrastructure as well as real-time data about their current or scheduled occupancy. In some implementations, the aerial facility service 215 can access a model for each aerial facility. The model can be indicative of the physical layout of the respective aerial facility. The model can indicate the location and dimensions of the landing pads, parking pads, storage areas, passenger walkways, restricted areas, etc. The model can be encoded with information indicating charger types and compatibilities, cooling devices and compatibilities, and other information about the infrastructure.

The aerial facility service 215 can process real-time data from an aerial facility to compute whether the facility has capacity for an aircraft to land, charge, etc. This can include determining whether the aerial facility will have an available landing pad, charger, and/or cooling infrastructure that may be needed by an aircraft. The aerial facility service 215 can also access records of facility specifications to compute whether the facility's landing and parking pads can accommodate the aircraft's shape and dimensions. The aerial facility service 215 can determine whether the facility's chargers and cooling infrastructure are capable to connect with the particular aircraft. This information can be transmitted to the flight operations services 225, which can be programmed to update the flight operations for any real-time changes in facility capacity.

The passenger itinerary service 220 can be programmed to aggregate the itineraries of passengers 255A-C that have requested transportation by aircraft. To do so, the passenger itinerary service 220 can communicate (e.g., via an API) with the associated devices 110. The passenger devices 110 can each run a software application 140 (a “passenger app”) that allows the respective passenger 255A-C to request transportation, in an on-demand manner. The request may be processed to create a passenger itinerary.

The passenger itinerary may include various information about the passenger and the passenger's desired journey. For example, the passenger itinerary can include the passenger's assigned flight as well as any service constraints. The service constraints can include, for example, the passenger's seat preferences. The passenger itinerary can store payload data indicating the weight of the passenger's payload, which can include the passenger plus and associated items such as luggage. The passenger itinerary may also describe a payload type and associated dimensions.

Payload data and other passenger data can be stored in a passenger record 385, shown in FIG. 3B. The passenger record 385 can be stored in a data structure. The data structure can include a table, list, array, etc. The data structure can include one or more cells or fields that include data entries. The entries can be written, removed, replaced, revised, etc. to update the information stored in the passenger record 385.

A passenger itinerary may include a single transportation leg, whereby the passenger is transported, by an aircraft, from an origin aerial facility to a destination aerial facility. In some implementations, the passenger itinerary may include multiple transportation legs. For instance, the passenger itinerary may include a multi-modal transportation service whereby the passenger travels by ground vehicle on a first leg, aircraft on a second leg, and ground vehicle on a third leg to reach the passenger's ultimate destination.

Returning to FIG. 2, the passenger itinerary service 200 can transmit the passenger itineraries to the flight operations service 225, to allow the flight operations service to assign the passengers 255A-C flights for fulfilling an aerial leg of a passenger's itinerary. The flight operations service 225 can transmit a signal to the passenger itinerary service 220 to provide passenger data (e.g., indicative of the payload weight, number/type/dimensions of payload items) to the user device 115.

The flight operations service 225 can be programmed to manage the flight scheduling for the aircraft and the pilot. This can include maintaining real-time records of flights, as those flights are created for an on-demand, aerial transportation service. The records can be indicative of the flight origin and destination, the flight times, route assignments, skylanes, etc. The flight operations service 225 can also be programmed to match an eligible aircraft with an eligible pilot compute an aircraft-pilot data object, which can be assigned to a particular flight.

The assignments can be maintained in a flight record 375, as shown for example in FIG. 3B. The flight record 375 can be stored in a data structure. The data structure can include a table, list, array, etc. The data structure can include one or more cells or fields that include data entries. The entries can be written, removed, replaced, revised, etc. to update the information stored in the flight record 375.

With reference to FIG. 2, the flight operations service 225 can communicate with a time of day service 245 and/or a weather service 250. For example, the time of day service 245 can be programmed to inform the flight operations service 225 what portion of the day is daytime (e.g., when there is sunlight) and what portion of the day is nighttime (e.g., no sunlight). The time of day service 245 may be programmed to automatically push this information to the flight operations service 225 or to transmit such information in response to a request message.

The weather service 250 can maintain a data record indicating the current and future weather conditions in the geographic areas in which the aircraft are/will be operating. The weather service 250 may be programmed to automatically push this information to the flight operations service 225 or to transmit such information in response to a request message.

The flight operations service 225 can be programmed to process the data from the time of day service 245 and the weather 250 when computing a flight schedule. For example, the flight operations service 225 may compute a flight schedule to minimize flights at night and/or to avoid poor weather conditions.

The resource manager service 240 can be programmed to analyze the primary resources that are needed to generate a flight and its associated parameters. For example, the resource manager service 240 can analyze: (i) available pilots and their associated flight hours, certifications, training, medical, etc.; (ii) available aircraft and their associated maintenance histories, upcoming scheduled maintenance, charging needs, etc.; and (iii) available aerial facilities and their associated landing pads, charging/cooling infrastructure, capacity, etc. The resource manager service 240 can manage this information for access by other services. For instance, the resource manager service 240 can regularly exchange data with the pilot record service 235 and the aircraft maintenance service 230.

The resource manager service 240 can include a facilitation service for the other software services. For example, the resource manager service 240 can publish relevant pilot data (e.g., certifications, remaining available flight times) for the pilot service 205 and the flight operations service 225. The resource manager service 240 can publish relevant aircraft data to the aircraft service 210, the flight operations service 225 and the aerial facility service 215. The resource manager service 240 can publish relevant facility data to the aerial facility service 215.

While the description herein describes certain software services illustrated in FIG. 2, these software services are provided as examples and are not intended to be limiting. The network system 105 can include more or less, or different types of software services.

The user device 115 can be operable to connect to the network system 105, over a network, to access data from one or more software services of the plurality of software services 205-295. The user device 115 can include a software architecture that allows the user device 115 to seamlessly integrate the functions of the software services for local, on-device computations.

The software architecture of the user device 115 can be developed to provide a client-facing front end for the software services of the network system 105. As described herein, the user device 115 can include one or more software applications 145 that are programmed to communicate with the back-end software services of the network system 105. The software applications 145 can include a schedule management application 260, a performance calculator application 265, a document management application 270, a web manual application 275, a vehicle squawk application 280, a pilot application 285, or other software applications.

The schedule management application 260 can provide a front-end interface via which a pilot can view and manage the pilot's schedule. The schedule management application 260 can access data by calling an API to compute a query for the pilot's schedule from the pilot service 205. The pilot service 205 can communicate (e.g., via an internal messaging protocol) with the flight operations service 225 to maintain an up-to-date schedule for the pilot.

The schedule can be dynamically changed throughout the day. For example, the pilot may be flying the aircraft for an on-demand transportation service. Given the on-demand nature of such a service, the pilot may not have a full schedule at the beginning of the day (or operating time period). Aerial transport may be requested by passengers, on-demand, throughout the day. Flights can be added, removed, and revised on the pilot's schedule as those requests are processed and the pilot is matched to flights created throughout the day.

The pilot service 205 can transit schedule data to the schedule management application 260, which can be programmed to render the schedule for the pilot via a user interface presented on the display of the user device 115. The pilot can view and request changes to the schedule by interacting with the user interface.

The performance calculator application 265 can be programmed to compute a determination that indicates whether the aircraft can perform a particular flight. For example, the performance calculator application 265 can be programed to determine whether a particular aircraft, given its state of charge and with the assigned passenger manifest, can perform the flight assigned to it, with regulatory compliance. This computation can also take into account the route assigned to the aircraft. The computation can also be based on the weight and balance computation performed by the pilot application 285.

In some implementations, the performance calculator application 265 can be programmed to compute a performance score for a particular flight. This may include, for example, computing battery performance for the aircraft flown by the pilot. In some implementations, the performance calculator application can be programmed to compute a performance score for the pilot based on the arrival time, route efficiency, charge level, noise production relative to environmental constraints, etc. The performance calculator application 265 can process data from the aircraft to perform its computations. The performance calculator application 265 can be programmed to render the scores for the pilot via a user interface presented on the display of the user device 115. In some implementations, the performance calculator application 265 can be programmed to transmit a data package to one or more of the software services for storage in association with the aircraft and/or pilot.

The document management application 270 can be programmed to provide a pilot with access to various documents. This may include certificates, training documents, previous flight logs, etc. The documents may be stored within the memory of the user device 115 or can be accessed via a software service of the network system 105 (e.g., pilot record service 235). In some implementations, the documents can be accessed via one or more databases 289 that are accessible to the user device 115 and/or the network system 105. The document management application 265 can be programmed to render the electronic versions of the documents for the pilot via a user interface presented on the display of the user device 115. This can allow the pilot to view and revise documents or select certain documents for transmission.

The web manual application 275 can be programmed to provide a pilot access to aircraft manuals. This can include, for example, manuals for the aircraft that the pilot is scheduled to fly. Once launched, the web manual application 275 can call an API to format a request for the pilot's schedule from a software service of the network system 105. The schedule may indicate the model/year of the aircraft or provide an identifier by which the web manual application 275 can query an accessible database 289 for the relevant manuals. The web manual application 275 can be programmed to render the electronic versions of the manuals for the pilot via a user interface presented on the display of the user device 115. The web manual application 275 can allow a pilot to search the manuals and/or save copies of the manuals to a local memory of the user device 115.

The aircraft squawk application 280 can be programmed to monitor and record the aircraft squawks associated with an aircraft. An aircraft squawk can include, for example, a code (e.g., four-digit code, transponder code, Mode A code) transmitted by an aircraft's transponder to Air Traffic Control (ATC) for identification and communication purposes. This code can be assigned by ATC and can be used to identify and track the aircraft on radar. The aircraft squawk application 280 can access data indicative of the vehicle squawks by communicating with the aircraft system 120. For example, the aircraft squawk application 280 can interface with the aircraft's transponder to request data that is being sent from the aircraft to ATC. The aircraft squawk application 280 can be programmed to compute a data package indicative of the vehicle squawks for an aircraft and its associated flight and transmit the data package to a back-end software service of the network system 105 (e.g., the aircraft service 210). This transmission may occur, for example, after the aircraft has landed from a flight. The aircraft squawk application 280 can be programmed to render a user interface that lists the aircraft squawks for viewing by the pilot. The aircraft squawks can be associated with the aircraft, a time stamp, a flight, the pilot, etc. The user interface can output this information for presentation on the display of the user device 115.

The pilot application 285 can be programmed to perform (on the user device) various computations for operating the aircraft. This can include automatically performing pre-and post-flight computations. For example, the pilot application 285 can be programmed to compute a flight risk assessment, perform an automatic weight and balance computation, display/confirm the pilot's and the aircraft's eligibility for a particular flight, render the flight manifest for the pilot, provide interactive pre-flight and post-flight checklists, or perform other aircraft operations. In some implementations, the pilot application 285 can be programed to compute a fatigue assessment of the pilot based on a fatigue survey that can be completed via a user interface displayed on the user device 115. The results of which can be communicated to the network system 105. The pilot application 285 can be programmed to provide notifications to the pilot. This can include notifications indicating delays, schedule shifts, updates on remaining available flight time, etc.

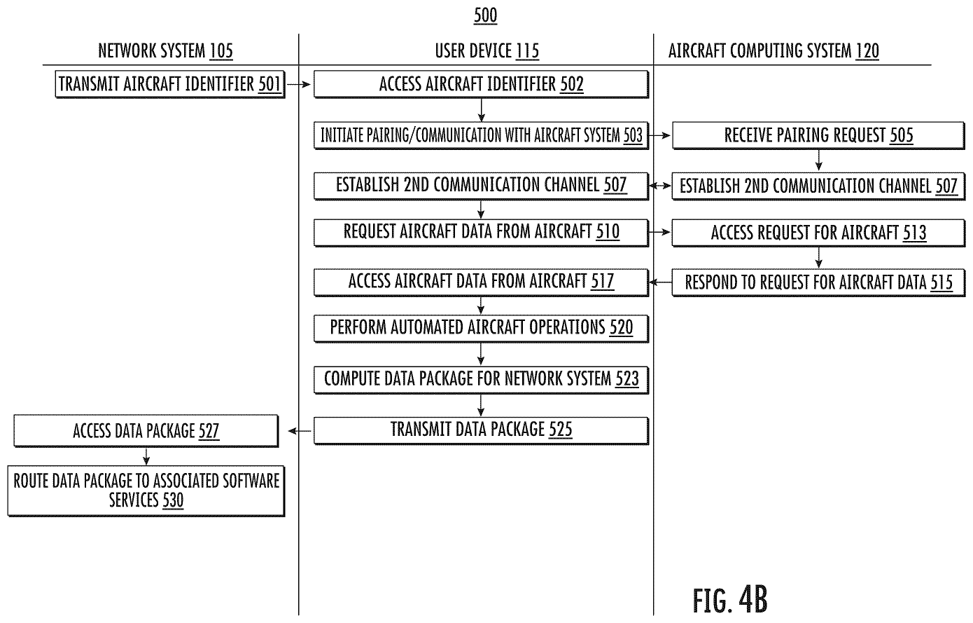

To perform its functions, the pilot application 285 can interface with various back-end software services of the network system 105. For instance, the pilot application 285 can access an API to format requests for data from the flight operations service 225, the pilot service 205, the aircraft service 210, and the passenger service 220. In some implementations, these services can be programmed to automatically push data to the pilot application 285 once the pilot application 285 is launched, the pilot is verified, and a secured communication channel is established between the network system 105 and the user device 115. A more detailed example of the operations of the pilot application 285 is provided with reference to FIGS. 4A-B.

In some implementations, the pilot application 285 can transmit data to a pilot log 287. For instance, after completing a flight, the pilot application 285 can compute the total flight time that the pilot accrued during the flight. The calculation of accrued flight time can be based on the applicable regulations. In some implementations, the flight time can be calculated based on data from the aircraft indicting certain timestamps such as take-off, landing, etc. Additionally, or alternatively, a pilot can manually enter relevant times.

The pilot application 285 can transmit a data package to the pilot log 287. The data package can be indicative of the amount of flight time accrued by the pilot during the flight. The data package can include an identifier associated with the pilot. The pilot log 287 can store this information and aggregate the pilot's flight time for a given time period (e.g., day, week, month) as well as a lifetime aggregated flight time. The pilot log 287 can be stored in a database that is accessible by the pilot record service 235 and/or a third party system 125 (e.g., of a regulatory body). The pilot log 287 can also be indicative of the aircraft flown by the pilot.

An aircraft can include the aircraft system 120 and its subsystems 150. As described herein, the subsystems 150 can include the various subsystems onboard the aircraft that help operate the aircraft as well as assist the pilot in doing so. This can include a mission display 261, a flight computer 262, an avionics system, digital gauges, an autonomy system, and other subsystems. The user device 115 can be programmed to establish a secure communication channel with the aircraft system 120 such that it can transmit and receive data streams to and from the aircraft system 120. The pilot application 285 (and/or the other applications) can be programmed to utilize the data from the aircraft system 120 in its computations as well as transmit aircraft data to the relevant back-end software services.

### Example Data Flow Within the Computing Ecosystem

The following provides an example data flow for establishing connections among the hardware systems of the computing ecosystem 100 as well as performing example aircraft operations. FIGS. 4A-B depict elements performed in a particular order for purposes of illustration and discussion. Those of ordinary skill in the art, using the disclosures provided herein, will understand that the elements of any of the processes and data flows discussed herein can be adapted, rearranged, expanded, omitted, combined, or modified in various ways without deviating from the scope of the present disclosure.

FIG. 4A depicts an example data flow 400 between the user device 115 and the network system 105 according to example implementations of the present disclosure.

At 405, the user device 115 can launch a software application such as, for example, the pilot application 285. The pilot application 285 can be launched in response to the pilot selecting a UI element (e.g., app icon) via user input provided to the user device 115 (e.g., a touch input, cursor input). Upon launch, the pilot application 285 can present a login screen for the pilot to enter credentials for accessing the pilot application 285. The credentials can include, for example, a username and password associated with the pilot. The user device can access the pilot credentials via the pilot login, at 410.

To connect with the network system 105, the user device 115 can be operable to establish a first communication channel with the network system 105. To do so, at 415, the user device 115 can initiate a handshake procedure with the network system 105 and the network system 105 can receive the handshake request at 420. This can include a transmission control protocol (TCP), SSL/TLS, or other type of handshake with the network system 105.

For example, in a TCP handshake, the user device can transmit an SYN packet to the servers of the network system 105. The SYN packet can contain an initial sequence number (ISN) used to track the bytes sent and received in the communication session. The servers of the network system 105 can respond to the user device with a SYN-ACK packet. The SYN-ACK packet can acknowledge the SYN request by including the client's ISN+1 and also include the servers'own ISN. The user device can send an ACK packet back to the servers. The ACK packet can acknowledge the servers'SYN-ACK by including the servers'ISN+1.

In some implementations, at 425, the network system 105 can verify the pilot's credentials during or after performing the handshake with the user device 115. This can include performing a look-up function in a whitelist table that lists the pilots that are registered with the network system 105 and are authorized to utilize the pilot application 285. This may include pilots that have an account with the network system 105 or its associated service entity. The handshake procedure and the verification can allow the network system 105 and the user device 115 to establish the first communication channel, at 430.

At 435, the user device 115 can request pilot schedule data from the network system 105. For example, the user device 115 can call an API 135 associated with the network system 105. The API 135 can include information for computing a query for the pilot service 205 or the flight operations service 225 to return the pilot's schedule of upcoming flights. The user device 115 can generate the query, which can include an identifier associated with the pilot. The user device 115 can transmit the formatted query to the network system 105, over a network 130, to request the pilot schedule data.

At 440, the network system 105 can access the request for the pilot schedule data. The request can be routed by an API gateway to the appropriate software service. For example, the API gateway can route the query for the pilot schedule data to the pilot service 205. The pilot service 205 can retrieve the pilot's schedule by querying a database using the pilot identifier encoded in the request from the user device 115. The pilot service 205 can compute a package indicative of the pilot schedule data and return it to the user deice 105, over a network 130.

At 450 and 455, the user device 115 can access the pilot schedule data and output it for the pilot. For example, the user device 115 can render an electronic version of the schedule via a user interface presented on the display of the user device 115. The rendered schedule can be interactive such that the pilot can scroll through the flights and select a flight to review or perform certain associated aircraft operations.

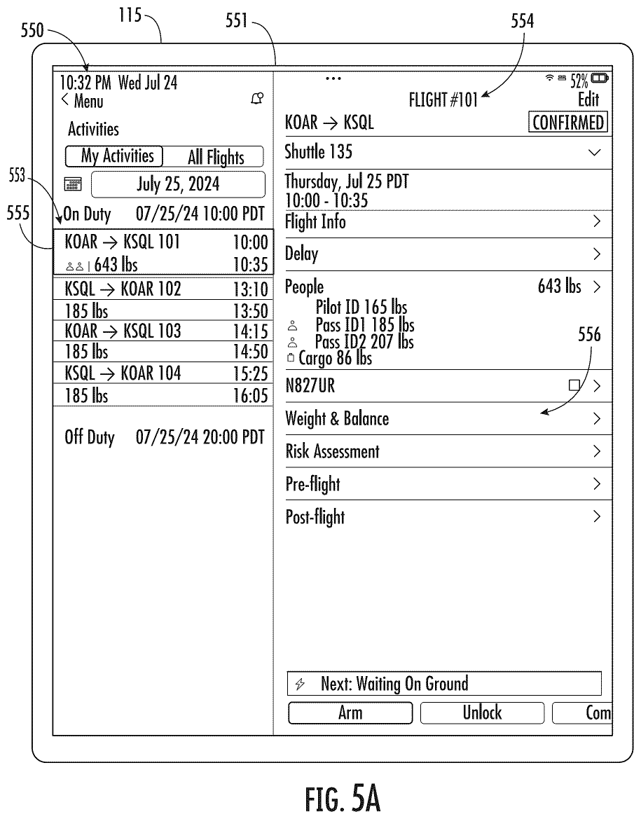

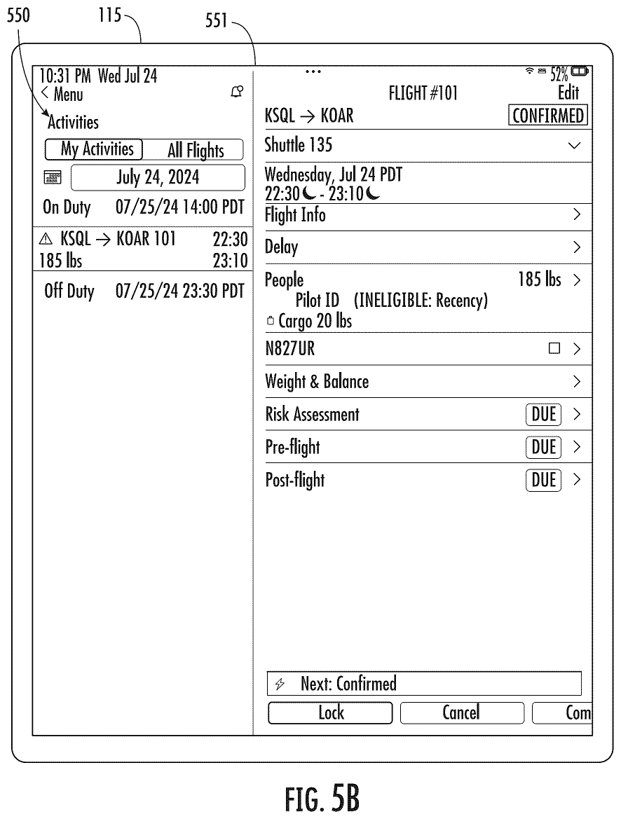

FIG. 5A depicts an example user interface 550 according to example implementations of the present disclosure. The user interface 550 can be presented on display hardware 551 (e.g., a display screen) of the user device 115. The user interface 550 can include an interactive schedule 553. The schedule 553 can include the one or more flights assigned to the pilot. A flight data object can be created for a particular flight.

Each flight can be represented by a UI flight element that depicts various data about the flight. The UI element can provide a visual representation of the flight data object that was computed for the associated flight. For example, a UI element for a first flight can indicate the origin, destination, flight number, number of passengers, pilot name, payload total, departure time, arrival time, and/or other information.

In the event that the pilot is ineligible to accept a flight, the user device 115 can output data indicative of the pilot's ineligibility. For example, as shown in FIG. 5B, the user interface 550 can present text, graphics, banners, or other notifications indicating that the pilot is ineligible for a flight. In some implementations, the user interface 550 can present information indicating the reason for the ineligibility.

Returning to FIG. 4A, at 460, the user device 115 can access data indicative of a selected flight. The selected flight can be a flight data object that is selected by the pilot. The pilot can select a flight by providing a user input to the UI element that represents the flight. The user input can include a touch input to a touchscreen, a cursor input, a voice input, gesture input, etc.

In response to a flight being selected, at 465, the user device 115 can request additional information about the flight from the network system 105. For example, the user device 115 can call an API 135 to compute a query for aircraft data from the aircraft service 210 and a query for passenger data from the passenger itinerary service 220 The query for the aircraft data can include an aircraft identifier indicative of the associated aircraft. The query for the passenger data can include a flight identifier indicative of the associated flight. The queries can be generated in a format that can be processed by the recipient software service. The user device 115 can transmit one or more requests, encoded with the queries, to the network system 105 over a network 130.

At 470, the network system 105 can access the requests for the aircraft data and the passenger data. The respective requests can be routed by an API gateway to the aircraft service 210 and the passenger itinerary service 220, respectively.

The aircraft service 210 can query a database using the aircraft identifier to access the requested aircraft data. The aircraft data can be indicative of at least one of: a charge level of the aircraft, battery SoH, a seat and cargo configuration of the aircraft, or a payload capacity of the aircraft.

The passenger itinerary service 220 can query a database using the flight identifier to access the requested passenger data. The passenger data can be indicative of the passenger manifest for the flight. In some implementations, the passenger data can be indicative of passenger seating/cargo storage preferences. In some implementations, passengers (and the pilot) can be associated with an identifier (e.g., UUID). Identifiers, rather than names, can be displayed in a user interface.

The passenger data can include payload data associated with a payload for the flight. The payload can include a plurality of individual payload items. The payload data can be indicative of at least one of: a weight for each respective payload item or dimensions for each respective payload item.

At 475, the aircraft service 210 and the passenger itinerary service 220 can compute response packages including the aircraft/passenger data and the network system 105 can transmit such data to the user device 115, over a network 130.

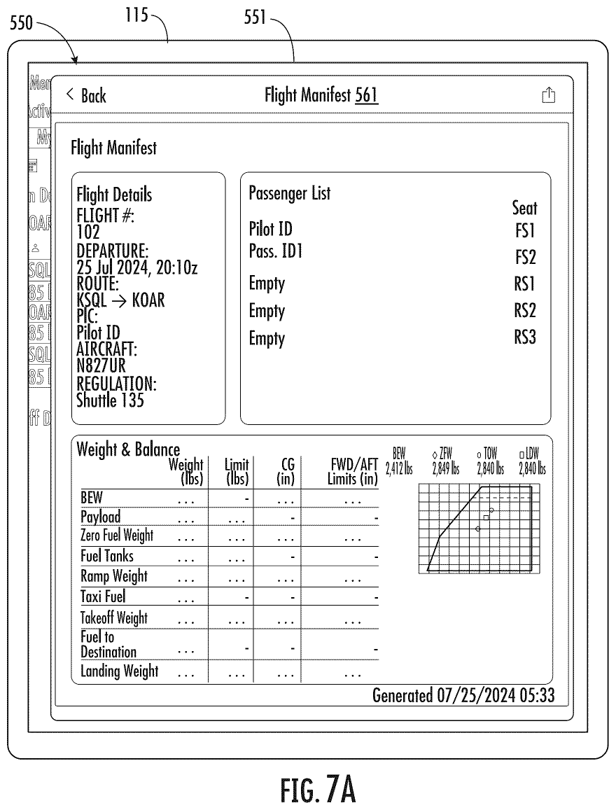

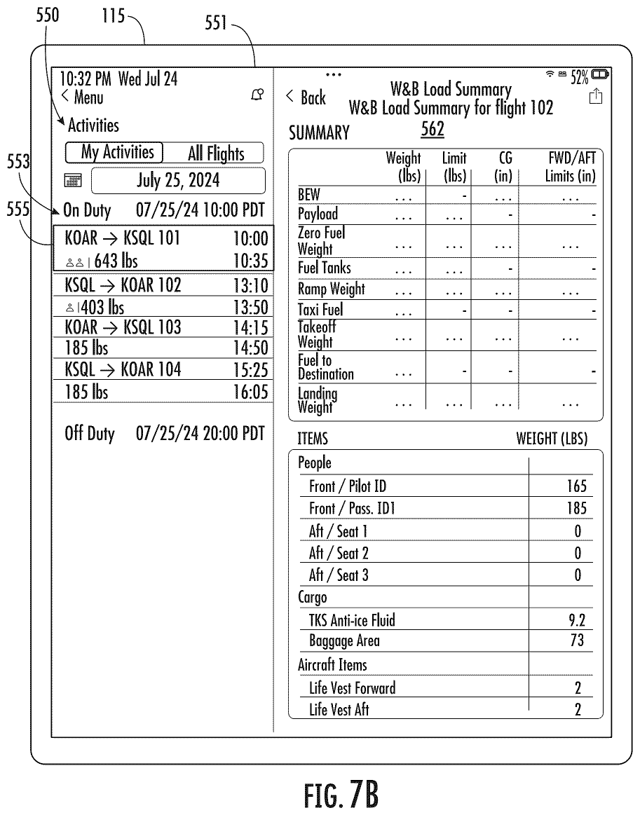

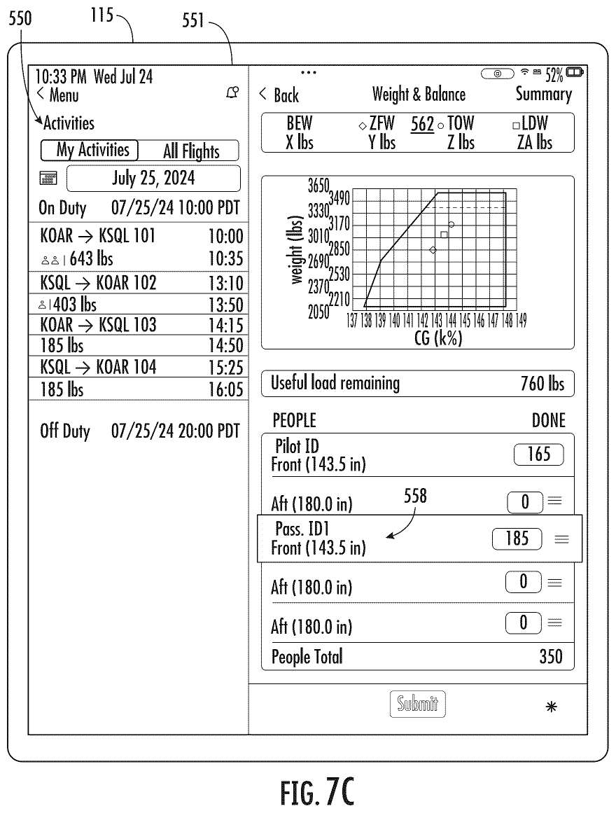

At 480, the user device 115 can access the aircraft data and the passenger data. The user device 115 can output the data for presentation via the user interface 550 of the user device 115. For example, as shown in FIG. 5A, the user device 115 can output additional information 554 associated with the selected flight 555. The additional information 554 can provide more or greater detail than the UI element for the selected flight 555. For example, the additional information 554 can indicate the provider of the aircraft (e.g., the service entity associated with the network system), adjustments in the departure/arrival times, delays, the passenger manifest, payload weights, cargo weights (e.g., for baggage, luggage), aircraft identifier, etc. The user interface 555 can present the additional information 554 for viewing and adjusting by the pilot, where possible. This can include, for example, a flight manifest 561 as shown in FIG. 7A.

Returning to FIG. 5A, the additional information 554 can present different aircraft operations that can be performed by the user device 115. For example, as described herein, the user device 115 can be operable to automatically perform one or more computing functions 556 for an aircraft based on the data from the one or more software services of the network system 105. The computing functions 556 can include a pre-flight computing functions and post-flight computing functions. At least one of the pre-flight computing functions can include an automated flight risk assessment. A least one of the pre-flight computing functions can include an automatic weight and balance computation for a payload of the aircraft based on the data accessed from the one or more software services of the network system 105. The pre-flight computing functions can include other tasks, such as aircraft component checks, charge level checks, or other tasks from a pre-flight checklist.

In some implementations, the pilot application 285 can include a pre-flight checklist that includes a portion of pre-flight tasks that are manually performed by the pilot and a portion of pre-flight tasks that can be automatically computed by the user device 115 (e.g., the pilot application 285). For example, check-list items to confirm that certain emergency equipment is on-board the aircraft may be performed manually. Check-list items associated with visibility can be automatically performed by the pilot application 285 communicating with the weather service 250 of the network system 105. Check-list items associated with a destination aerial facility can be performed by the pilot application 285 communicating with the aerial facility service 215.

The pilot can be prompted by the pilot application 285 running on the user device 115 to confirm the automated tasks.

In some implementations, the pre-flight checklist can be generated by a checklist application 291 that is separate from the pilot application 285, shown in FIG. 2. The checklist application 291 can generate a user interface that allows the pilot to indicate which of the checklist items have been complete as well as enter any values requested by the checklist.

The checklist application 291 can call a checklist back-end 293. The checklist back-end 293 can be separate from the network system 105. The checklist back-end 293 can communicate (e.g., over one or more networks) up-to-date checklists and procedures for the checklist application 291 to surface in the user interface for the pilot.

The checklist application 291 can generate messages for transmission to the checklist back-end 293 over one or more networks. The messages can include, for example, the completed checklists, information included in or otherwise associated with the checklist, or information related to checklist items that have not been completed. Such information can be stored by the checklist back-end 293. The checklist back-end 293 may communicate data to and receive data from the network system 105 (or the aircraft system 120).

In some implementations, the user device 115 can generate a checklist without communicating with the checklist back-end 293. For example, the checklist back-end 293 can communicate with the network system 105. The network system 105 can cache the latest checklist data/items for the pilot to complete pre-and post-flight. In the event that the user device 115 does not have a network connection with the checklist back-end 293, the user device 115 can communicate with the network system 105 to access the checklist data cached in the network system 105. This provides a redundant system back-up to overcome technical issues associated with network connectivity interruptions.

At 485, the user device 115 can perform the automatic weight and balance computation. For example, the user device 115 can be operable to process the aircraft data and the payload data (e.g., including the passenger data returned from the network system 105) to compute a payload configuration. The payload configuration can define a position of each respective payload item within the seat and cargo configuration of the aircraft based on: the payload capacity of the aircraft and at least one of the weight or dimensions for each respective payload item. In some implementations, the user device 115 can be operable to compute the payload configuration based on the charge level of the aircraft.

By way of example, the pilot application 285, of the user device 115, can be programmed to ingest the aircraft data and payload data, and automatically compute a recommended payload configuration for the aircraft. Given the respective payloads of the passengers, the pilot application 285 can be programmed to iteratively generate different combinations of seat assignments and cargo storage assignments within the interior arrangement of the aircraft. The pilot application 285 can continue its iterative processing until a specific combination provides a payload configuration that meets the balance constraints of the aircraft. The analysis can also take into account the seating preferences and requests from the individual passengers.

The automatic weight and balance computation can include an automatic seat assignment functionality. This can generate recommended seat assignments for inclusion in the recommended payload configuration.

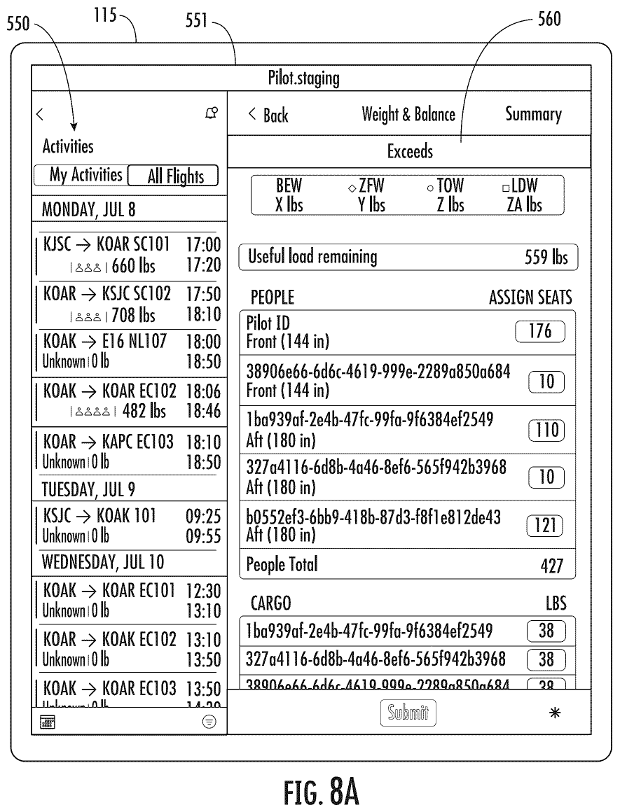

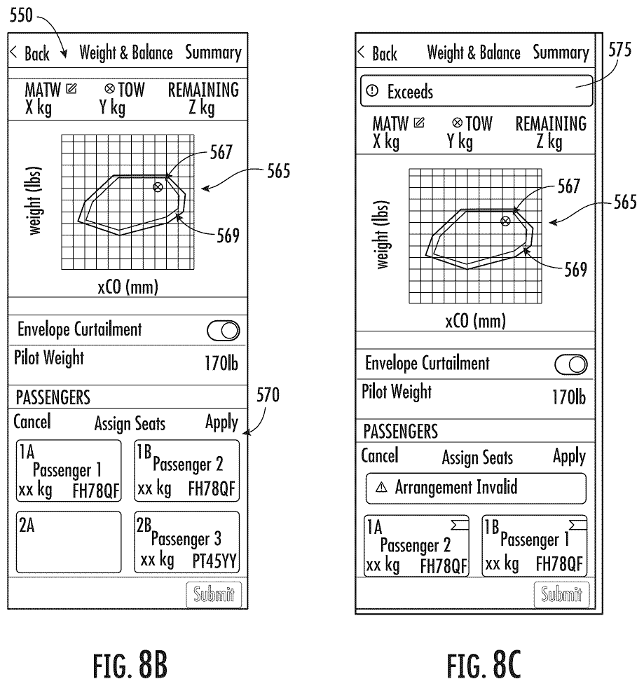

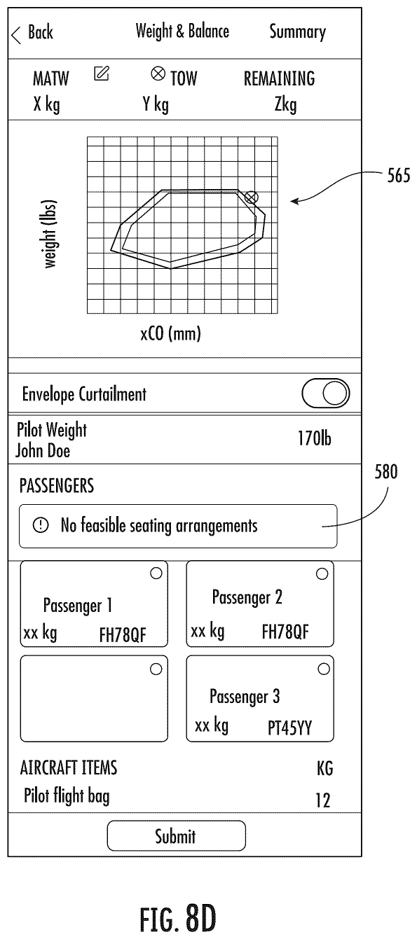

In some implementations, the automatic seat assignment functionality can be associated with a seat assignment service 295 of the network system 105. The seat assignment service 295 can be configured to compute a recommended arrangement of passengers within the aircraft, given the aircraft's available seating. The recommended arrangement of passengers can be computed for improved aircraft and battery performance. This can be accomplished by arranging passengers to determine a position the aircraft's center of gravity. The seat assignment service 295 can select the particular seat assignment combination that does not violate the aircraft's operating constraints and positions the center of gravity in a way that maximizes the aircraft's battery efficiency/burn rate for its upcoming flight (e.g., considering the amount of time/distance the aircraft is to be in cruise and hover modes). The recommended seat assignment can be provided to the pilot application 285 for display to the pilot via a user interface, as described with reference to FIGS. 8B-D.

In some implementations, the automatic seat assignment functionality can run on the user device 115 via the pilot application 285, without communicating with the seat assignment service 295 (e.g., when there is no network connection to the network system 105).

In the event that more than one combination meets the weight and balance constraints, the pilot application 285 can apply a weighting algorithm to secondary factors to help automatically select a combination. This may include, for example, favoring the combination in which more passengers are more closely aligned with their seating and/or cargo preferences. In another example, this may include favoring the combination in which passengers are seated closer to their cargo.

Additionally, or alternatively, the pilot application 285 may be programmed to more favorably weigh a combination where a passenger with a sooner ETA (provided to the passenger at booking) is seated near an exit of the aircraft with easier access to the passenger's cargo. The passenger data acquired by the user device 115 can indicate the passenger's ultimate ETA and/or if the passenger is under tighter time constraints relative to their fellow passengers. The pilot application 285 can parse this information when computing the recommended payload configuration to identify a preferred seating/cargo combination. This can allow such passenger to more easily exit the aircraft and more quickly reach a subsequent mode/leg of transportation, helping to avoid violation of the passenger's ETA. As such, the weight and balance computation can help facilitate a multi-modal transportation service.

At 487, the user device 115 can output the recommended payload configuration. For example, the user device 115 can be operable to output data indicative of the payload configuration for display via a user interface of the user device 115.

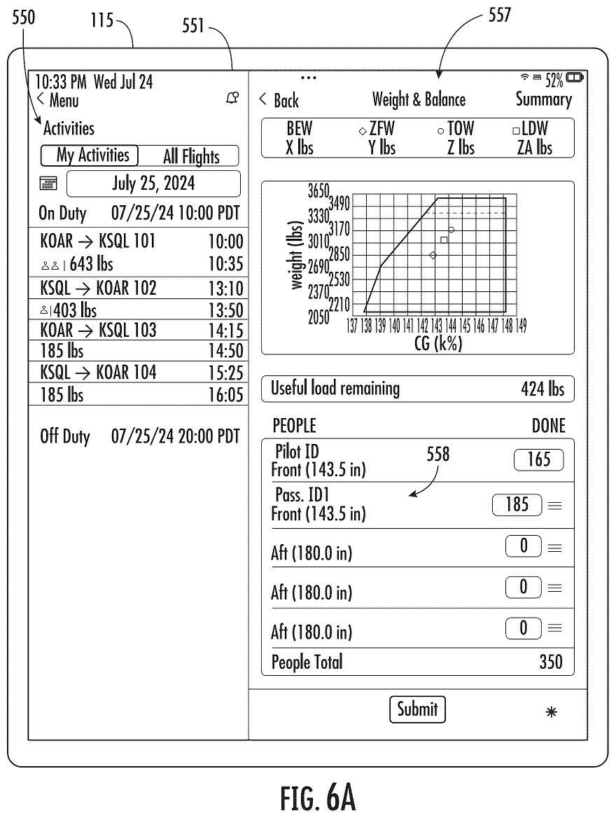

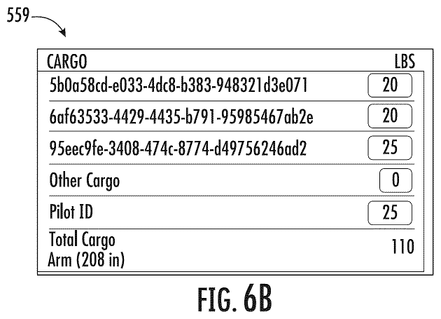

As shown in FIG. 6A, the user device 115 can output the recommended payload configuration 557 via the user interface 550 that is presented on the display hardware 551 of the user device 115. The payload configuration 557 can include a passenger element 558. The passenger element 558 can be a UI element that includes a list of the passengers with associated weights and seat assignments. The passenger element 558 can include a total passenger weight. The payload configuration 557 can also indicate the user load remaining to indicate how much additional payload weight can be tolerated by the aircraft. The payload configuration 557 can include one or more graphical references (e.g., graphs, charts) associated with the weight and balance computation.

As shown in FIG. 6B, the payload configuration 557 can include a cargo element 559. The cargo element can be a UI element that includes a list of the cargo items with associated weights and cargo positions within the aircraft. The cargo element 559 can include a total cargo weight.

Additionally, or alternatively, the user device 115 can be operable to output a weight and balance summary 562, as shown in FIG. 7B. This can include the above described information as well as payload data indicative of takeoff weight, landing weight, non-passenger cargo weight (e.g., from anti-ice fluid, life vests).

The passenger element 558 and the cargo element 559 can be interactive UI elements. For instance, as shown in FIG. 7C, the pilot application 285 can be programmed to render the passenger element 558 such that a pilot can provide user input to the passenger element 558 to adjust the seating position of one or more of the passengers. This can include a drag and drop interaction for a UI element that represents an individual passenger. Adjusting the position of the UI element can change the seat of the passenger. For example, moving a UI element up in the passenger element 558 order, can shift the passenger's seat towards the front of the aircraft. Moving a UI element down in the passenger element 558 order, can shift the passenger's seat towards the back of the aircraft. In some implementations, moving a UI element left or right in the passenger element 558, can shift the passenger's seat left or right within the aircraft.

Additionally, or alternatively, the pilot application 285 can be programmed to render the cargo element 559 such that a pilot can provide user input to the cargo element 559 to adjust the storage position of one or more cargo items. This can include a drag and drop interaction for a UI element that represents an individual cargo item. Adjusting the position of the UI element can change the storage position of the cargo item. For example, moving a UI element up in the cargo element 559 order, can shift the cargo item's storage position towards the front of the aircraft. Moving a UI element down in the cargo element 559 order, can shift the cargo item's storage position towards the back of the aircraft. In some implementations, moving a UI element left or right in the cargo element 559, can shift the cargo item's storage position left or right within the aircraft.

In some implementations, the user interface 550 can indicate whether a particular payload configuration violates the weight and balance constraints of the aircraft. With reference to FIG. 8A, the user interface 550 can include a notification element 560. The notification element 560 can indicate whether a particular payload configuration would violate the weight and balance constraints of an aircraft. For example, a pilot may adjust one or more passenger seat assignments or one or more cargo storage positions within the aircraft. In the event that the updated seat assignments or cargo storage positions would violate the weight and balance constraints of the aircraft, the pilot application 285 can be programmed to output a notification to the pilot indicating the violation. The notification can be rendered as the notification element 560, which can alert the pilot of the violation.

In some implementations, the pilot application 285 can render the automatic seat assignment recommendations in a manner that orients the passengers within the aircraft. This can be provided as part of the payload configuration.

For example, as shown in FIG. 8B, the user interface 550 can display a UI element indicative of the recommended seat assignment 570. The recommended seat assignment 570 can be generated by the pilot application 285 or the seat assignment service 295 based on the pilot selecting a user interface element (e.g., tapping a soft button to request the recommendation). The recommended seat assignment 570 can show the arrangement of the passengers oriented within the cabin of the aircraft. For example, seats 1A and 1B may be adjacent to one another (e.g., left/right) and respectively in front of seats 2A and 2B (e.g., towards the pilot seat) within the aircraft. The UI element indicative of the seat assignment recommendation 570 can reflect the seat configuration of the aircraft. For example, as in FIG. 2B, a 2×2 matrix or other data structure can be used to represent the seating configuration of the aircraft. This can include the configuration of seats 1A/B and 2A/B within the aircraft.

In some implementations, one or more cargo/storage areas within the aircraft can be represented within the user interface 550. Similar to the recommended seat assignment 570, a recommended payload assignment can indicate areas within the aircraft for cargo or other non-passenger payload items. The areas can be rendered within the user interface 550 to represent the actual orientation of the storage areas within the aircraft relative to one another and/or the seats.

The UI element indicative of the seat assignment recommendation 570 can be interactive. For instance, the arrangement of passengers within the seat configuration can be adjusted by the pilot based on user input to the UI element. In an example, the pilot can select (e.g., by tapping, a touchscreen, clicking) a passenger/seat and change the passenger to another seat by selecting (e.g., tapping, a touchscreen, clicking) another passenger/seat. Additionally, or alternatively, the pilot can drag a UI element/object indicative of a passenger from one seat to another to reassign the passenger to another seat.

By way of example, with reference to FIGS. 8B and 8C, the pilot can select passenger 1 and then select passenger 2, or vice versa, to change the passenger 1 from seat 1A (as in FIG. 8B) to seat 1B (as in FIG. 8C) and passenger 2 from seat 1B (as in FIG. 8B) to seat 1A (as in FIG. 8C).

In some implementations, a UI element indicative of the payload assignment recommendation can be interactive. For instance, the arrangement of cargo items (e.g., luggage, baggage, food item) within the storage area configuration can be adjusted by the pilot based on user input to the associated UI element. In an example, the pilot can select (e.g., by tapping, clicking) a cargo item and change the cargo to another storage area by selecting (e.g., tapping, clicking) another storage area. Additionally, or alternatively, the pilot can drag a UI element/object indicative of a cargo item from one storage area to another to reassign the cargo to another storage area. In some implementations, a cargo item can be assigned to a seat of the aircraft.

The pilot application 285 can indicate a center of gravity (CG) of the aircraft based on a particular seat/cargo arrangement. For example, the user device 115 (via the pilot application 285) can render a CG element 565 indicating a CG identifier 567 within an aircraft representation 569. The aircraft representation 569 can include, for example, a shape indicating bounds of the aircraft. The position of the CG identifier 567 within the representation 569 can indicate where the center of gravity of the aircraft is located given the seat assignment currently displayed within the user interface 550 (e.g., the recommended seat assignment 570), as shown in FIGS. 8B and 8C.

The position of the CG identifier 567 within the aircraft representation 569 can change as the seat assignments or cargo storage area assignments are changed by the pilot to indicate where the center of gravity of the aircraft is given the seat/cargo assignment. By way example, FIG. 8C displays an updated position of the CG identifier 567 within the aircraft representation 569 when passenger 1 is changed to seat 1B and passenger 2 is changed to seat 1A.

The user device 115, via the pilot application 285, can render a UI element indicative of a CG warning 575, as in FIG. 8C. The warning 575 can indicate if the center of gravity is outside a threshold or otherwise violates the constraints of the aircraft. The warning 575 can indicate that the center of gravity of the aircraft for a particular seat/cargo assignment would not be recommended for operating the aircraft. Additionally, or alternatively, the CG identifier 567 can be shown outside the aircraft representation 569, as shown in FIG. 8C. In the event the pilot changes to a new seating assignment, or a new recommended seat assignment is computed, that would bring center of gravity to an acceptable position, the warning 575 can be removed from the user interface 550.

In some implementations, the user interface 550 can indicate that there are no acceptable seating/cargo arrangements given the current passengers or cargo assigned to the aircraft. For instance, the user device 115, via the pilot application 285, can render a feasibility element 580 indicating that no feasible seating arrangements and/or cargo arrangements exist for the current assigned passengers/cargo, as shown in FIG. 8D. The pilot application 285 can indicate to the network system 105 that one or more of the passengers or cargo items is to be reassigned to another aircraft.

In some implementations, components of the aircraft can be adjusted to adjust the center of gravity such that it is within an acceptable range for performing a flight, without further adjustment of the passengers or cargo. For example, the position of the pilot seat or a ballast in the aircraft can be adjusted to change the center of gravity of the aircraft. The user interface 550 can include one or more interactive UI elements that allow the pilot to indicate a position of the pilot seat or adjust the ballast. The pilot application 285 can update the position of the CG identifier 567 based on the position of the pilot seat or the ballast configuration. In this way, the pilot has the option of shifting one or more non-passenger or non-cargo components of the aircraft to affect the center of gravity, before requesting reassignment of passengers or cargo.

Returning to FIG. 4A, at 490, once the pilot determines an appropriate payload configuration for the flight, the pilot can confirm the payload configuration by providing user input to the user interface 550 of the pilot application 285.

At 493, the user device 115 can be operable to transmit, over a network 130, data indicative of the payload configuration to the network system 105. For example, the user device 115 can access an API to format a data package that is appropriate for the network system 105. The data package can be indicative of the confirmed payload configuration and can be transmitted to the network system 105. At 495, the network system 105 can access the data package indicative of the payload configuration and route the data package to the appropriate software services (e.g., the aircraft service 210).

At 497, the user device 115 can perform other aircraft operations. For example, as described herein, the pilot application 285 can be programmed to perform a flight risk assessment as well as guide the pilot through addition pre-flight procedures.

The example user interfaces of FIGS. 5-8 can be dynamically adjusted based on the operating context of the aircraft and its corresponding flight. For example, the pre-flight checklist can be adjusted based on the geographic region in which the aircraft is operating. The geographic region may be associated with a certain regulatory body that requires different pre-flight tasks than another region. Similarly, the post-flight checklists and corresponding tasks may be different based on the associated geographic region.

In some implementations, the user interfaces may be adjusted based on the flight type. For example, a P135 flight may have different computations (e.g., pre-flight, post-flight) than other types of flight. The user interfaces and computations can be adjusted and populated in the user interfaces based on the flight type.

As described herein, the ecosystem 100 can include the aircraft system 120 of an aircraft. The user device 105 can be operable to connect with the aircraft system 120. This can allow the user device 105 to send and receive data from the aircraft system 120, and vice versa.

FIG. 4B depicts an example data flow 500 between the user device 115, the aircraft system 120, and the network system 105 according to example implementations of the present disclosure.

At 501, the network system 105 can transmit an aircraft identifier associated with the aircraft to the user device 105. Data indicative of the aircraft identifier can be transmitted in response to an explicit request for the aircraft identifier, included within a package of other data (e.g., a pilot's schedule), or pushed automatically in response to an action by the user device 115 (e.g., the pilot logging into a software application). The user device 115 is operable to access data indicative of an aircraft identifier from the network system 105, at 502.

The user device 115 can be operable to connect with the aircraft system 120 based on the aircraft identifier. To connect with the aircraft system 120, the user device 115 can be operable to establish a second communication channel. For example, at 503, the user device 115 can initiate a pairing sequence with the aircraft system 120. The pairing can include near-field communication, Bluetooth® protocol, or other protocols/technology for pairing.

Using its communication hardware (e.g., antennae, transmitter) the user device 115 can perform a discovery and connection process to initiate the pairing. The user device 115 can determine that the aircraft system 120 supports pairing via a particular technology (e.g., Bluetooth®). In some implementations, this can be accomplished by the aircraft system 120 broadcasting its presence to nearby devices. The user device 115 can match the aircraft identifier to the broadcasted data to identify the aircraft system 120 as the pairing target. The user device 115 can send a pairing request to the aircraft system 120. One or both of the user device 115 or the aircraft system 120 can request a PIN or some code for verification. In some implementations, the PIN can be sent with the aircraft identifier from the network system 105. In some implementations, the PIN can be the aircraft identifier. Once authenticated, the user device 115 and the aircraft system 120 can exchange encryption keys to establish the secure, second communication channel, at 507.

In an example, the second communication channel is separate from the first communication channel between the user device 115 and the network system 105. For instance, the communication channels can be established using different protocols/technologies, as well as different networks. The communication channels can also have different levels of connectivity strength based on the position/status of the aircraft.

By way of example, the second communication channel between the user device 115 and the aircraft can be maintained while the aircraft is in-flight from an origin to a destination. The first communication channel can be disconnected for a least a time period while the aircraft is in-flight from the origin to the destination. The first communication channel can be reestablished when the aircraft reaches the destination. In another example, the first communication channel may be disconnected for more than one flight. The connection may be re-established after the completion of more than one flight. The user device 115 may be configured to continue performing computations and operations without the established first communication channel. These computations may be based on data obtained prior to channel disconnection or data obtained from another source (e.g., the aircraft).

In some implementations, the user device 115 may access additional information about the aircraft or its subsystems from the network system 105. For instance, the different aircraft can have different versions, models, or manufacturers of navigation systems. The user device 115 can access, from the network system 105, data indicative of the version/model/manufacturer of the navigation system. The user device 115 can utilize this data to compute a communication that can be provided to the navigation system or to process information received from the navigation system. In this way, the user device 115 can access data from the network system 105 in a manner that allows the user device 115 to better utilize the data from the aircraft's subsystems.

The user device 115 and the aircraft system 120 can utilize the second communication channel to exchange data before take-off, during take-off, during a flight, during landing, or after landing. For instance, at 510, the user device can request aircraft data from the aircraft. At 513, the aircraft system can access the request for the aircraft data. The aircraft system 120 can process the request and communicate with its various subsystems to acquire the requested data. The aircraft system 120 can compute a data package with the requested aircraft data (e.g., battery SOH, charge level) and respond to the request, at 515. The user device 115 can access the aircraft data from the aircraft over the second communication channel, at 517.

At 520, the user device 115 can perform automated aircraft operations based on the aircraft data from the aircraft system 120. The user device can perform one or more pre-flight, inflight, or post-flight operations based on the aircraft data.

By way of example, the user device 115 can request aircraft data from the aircraft when performing pre-flight computing functions. This can include requesting data indicative of a current charge level of the aircraft. The charge level can be used when performing the flight risk assessment, weight and balance computation, etc. The aircraft system 120 can be operable to communicate with a subsystem associated with its batteries to compute the current charge level of the aircraft and transmit the requested data to the user device 115. This type of information can also, or alternatively, be accessed by the user device 115 during flight and/or post-flight.

In another example, the user device 115 can request temperature data indicating the temperature within the interior cabin of the aircraft or of a particular component. The aircraft system 120 can be operable to communicate with the sensor systems that measure and monitor the temperature of the interior cabin or various components. The aircraft system 120 can transmit such information to the user device 115 over the second communication channel. This type of information can be accessed by the user device 115 pre-flight, inflight, and/or post-flight.

In another example, during a flight, the user device 115 can request data indicative of the aircraft's location, route progress, route updates, skylane, orientation (e.g., yaw, pitch, roll), payload configuration chance, or other flight/performance parameters. The aircraft system 120 can be operable to communicate with its various subsystems to access this requested data while the aircraft is inflight.

Although the first communication channel between the user device 115 and the network system 105 may temporarily be disconnected while the aircraft is inflight, the second communication channel may remain established such that the aircraft system 120 and the user device 115 can transmit data back and forth. This can allow the user device 115 to collect information from the aircraft and store it in its local memory until the first communication channel is reestablished (e.g., after the aircraft lands).

While inflight, the user device 115 can be a useful resource to the pilot, even if the first communication channel is disrupted. For example, the pilot application 285 can download certain data to the local memory of the user device 115, while the first communication channel is established. This can include, for example, emergency checklists, operation checklists, running checklists, landing checklists, off nominal checklists, or other information that the pilot may utilize while in flight. By storing it in a local memory, the pilot application 285 can make this information available to the pilot during a flight. After the flight, the pilot application 285 may remove this data from the local memory and access/store similar such for the pilot's next flight.

At 523, the user device 115 can compute a data package for transmission to the network system 105. The data package can be computed based on an API 130 of the network system 105 such that portions of the data package are routed to the appropriate software services.

The data package can include and/or be based on the aircraft data received from the aircraft system 120. For example, the data package can include data indictive of the status and/or results from various pre-flight computing functions that were completed based on the aircraft data (e.g., charge level, temperature level, component status). Additionally, or alternatively, the data package can include an updated data package that includes various parameters accessed from the aircraft system 120 during flight. The updated data package can include aircraft data acquired after the flight and/or data computed as a result of post-flight computing functions. This can include, for example, pilot flight time data or aircraft performance data. The pilot flight time data can include the amount of flight time incurred by the pilot in performing the flight. The aircraft performance data can be indicative of the aircraft's flight time, hover time, flight speed, route efficiency, charge/fuel efficiency, or other indicators of aircraft performance.

At 525, the user device 115 can transmit the data package to the network system 105 over a network 130. For example, the user device 115 can be operable to transmit the updated data package to the network system 105 after the first communication channel is reestablished (e.g., after the aircraft lands).

At 527, the network system 105 can access the data package transmitted by the user device 115 over a network 130. The network system 105 can route the data package to associated software services, at 530. For example, an API gateway can be used to route portions of the data package to one or more software services that are configured to ingest such data. For example, the pilot service 205 may receive pilot flight time data and updated its records accordingly for the particular pilot. In another example, the aircraft service 210 may receive aircraft performance data and update its records accordingly for the particular aircraft. In this way, the software services of the network system can remain up to date without relying solely on a third party system that may maintain data from the aircraft or pilot.

### Example Computer-Implemented Processes

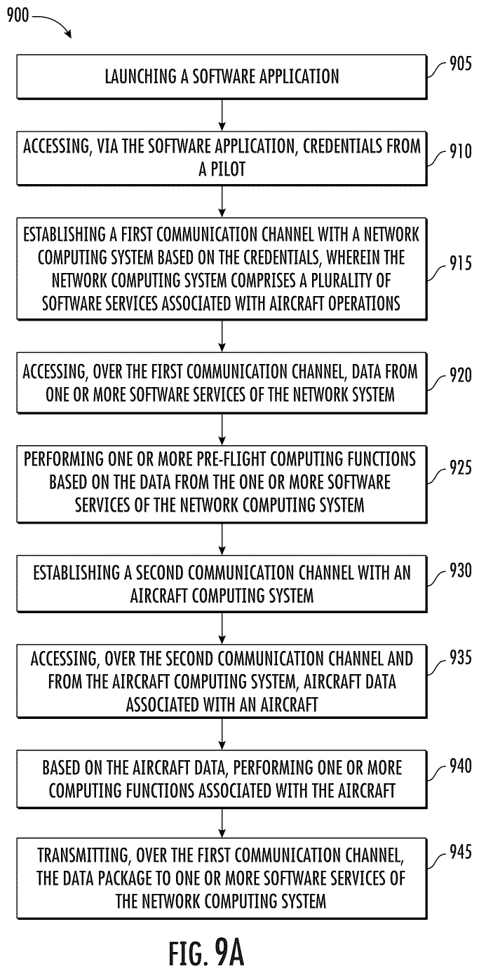

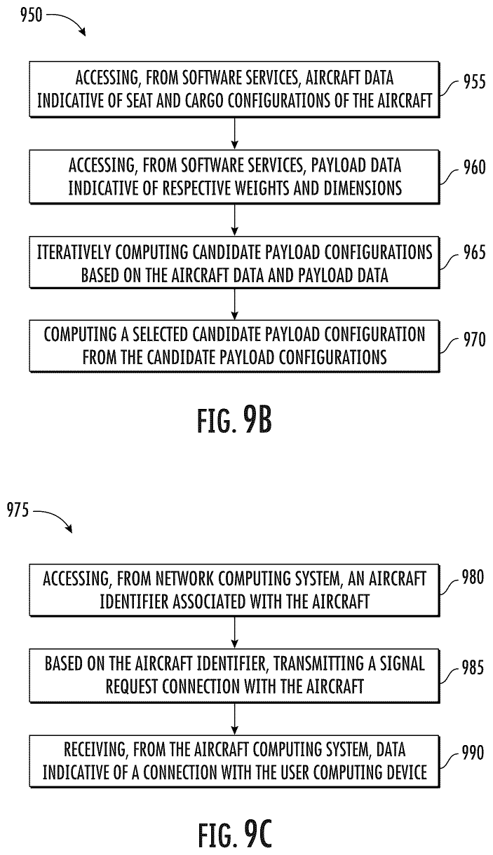

FIGS. 9A-C depict flowchart diagrams of example computer-implemented methods according to example embodiments of the present disclosure. The methods can be performed by a computing system that includes one or more computing devices such as, for example, the user device or other computing systems described with reference to the other figures herein. Each respective portion of the methods can be performed by any (or any combination) of one or more computing devices. Moreover, one or more portions of these methods can be implemented as one or more algorithms on the hardware components of the devices described herein to perform the functions described herein.

FIGS. 9A-C depict elements performed in a particular order for purposes of illustration and discussion. Those of ordinary skill in the art, using the disclosures provided herein, will understand that the elements/operations of any of the methods discussed herein can be adapted, rearranged, expanded, omitted, combined, or modified in various ways without deviating from the scope of the present disclosure.

FIGS. 9A-C are described with reference to elements/terms described with respect to other systems and figures for exemplary illustrated purposes and are not meant to be limiting.

One or more portions of the methods can be performed additionally, or alternatively, by other systems.

FIG. 9A is a flowchart diagram of an example computer-implemented method 900 for leveraging back-end software services for performing computing functions for an aircraft according to example embodiments of the present disclosure.

At 905, a computing device (e.g., a user computing device) can launch a software application. For example, the computing device can include a one or more software applications. The software application can be programmed to perform various functions for a pilot, transportation service, and/or aircraft. This can include a pilot application, as described herein. A user, such as a pilot, can provide a user input to the computing device to initiate the launch of the software application. The user input can include, for example, a touch input to a user interface presented on a touchscreen.

At 910, the computing device can access, via the software application, credentials from a pilot. The software application can include a login interface for a pilot of the aircraft. For example, after launching, the pilot application can provide a prompt to the pilot. The prompt can be presented within a login screen and can request the pilot's credentials. The credentials can include a username or identifier as well as a password. In some implementations, two factor authentication can be utilized to log into the pilot application.

At 915, the computing device can establish a first communication channel with a network computing system based on the credentials. For example, the computing device can be operable to perform a handshake with the network system to establish a first communication channel between the network system and the computing device. As described herein, this can include a transmission control protocol (TCP), SSL/TLS, or other type of handshake with the network system 105. The computing device and the network system 105 can exchange encryption keys to secure the first communication channel.

At 920, the computing device can access, over the first communication channel, data from one or more software services of the network system 105. As described herein, the network system 105 can be associated with a service entity that coordinates aerial transportation for passengers. The network system 105 can include one or more back-end software services associated with aircraft operations. The software services can include at least one of: a pilot software service, an aircraft software service, a passenger software service, an aerial facility software service, a flight operations software service, an aircraft maintenance software service, or another back-end software service.

To access data from the software services, the computing device can access an API associated with the network system 105. The API can include definitions for formatting a query for certain data from the network system 105. The computing device can compute a request for the data from the one or more software services based on the API. The request can include one or more queries for the data from the one or more software services. The computing device can transmit, over the first communication channel, the request for the data from the one or more software services. Transmission over the first communication channel can include sending an encrypted message through the communication channel, over a network that connects the computing device and the network system 105.

The network system 105 can access the request via the first communication channel. The network system 105 can include an API gateway the is operable to route the queries (formatted using the API) to the appropriate software services. For example, using the API gateway, the network system 105 can route a query for schedule data to a flight operations service 225, route a query for aircraft data to an aircraft service 210, route a query for payload data to a passenger itinerary service 220, or route a query for pilot data to a pilot service 205. The respective software services can access the query and perform a function (e.g., look-up function, database query) to retrieve the requested data. The software services can compute a response that includes a data package with the requested data and transmit the response to the computing device over the first communication channel. The computing device can access the response and download the requested data to its memory.

At 925, the computing device can perform one or more computing functions based on the data from the one or more software services of the network computing system. This can include performing one or more pre-flight computing functions. Additionally, or alternatively, this can include performing one or more post-flight computing functions or computing functions while the aircraft is inflight.

By way of example, at least one of the pre-flight computing functions can include an automatic weight and balance computation for a payload of an aircraft. The computing device can perform the automatic weight and balance computation based on the data accessed from the one or more software services of the network system 105.

For example, FIG. 9B is a flowchart diagram of an example computer-implemented method 950 for performing a weight and balance computation for an aircraft on a local client device according to example embodiments of the present disclosure.

At 955, the computing device can access, from software services, aircraft data indicative of seat and cargo configurations of the aircraft. As described herein, the computing device (e.g., the pilot application) can request such data from the network system 105 by utilizing an API. The request can include a query for the specifications of the aircraft assigned to a given flight on the pilot's schedule. The specifications can indicate the aircraft's payload capacity (e.g., by weight, dimensions), its seating arrangement, cargo storage arrangement, etc. This can include, for example, the seat and cargo arrangement within a vertical take-off and lift (VTOL) aircraft that includes space for four to six passengers and their accompanying personnel items or luggage.

At 960, the computing device can access, from software services, payload data indicative of respective weights and dimensions. The computing device can utilize the API to format a request for the network system's passenger itinerary service. This request can include a query for payload data indicative of the passenger manifest and associated payload weights for the given flight. In response to the requests, the software services can compute one or more data packets including the aircraft data and payload data, and transmit the data packets over a network back, via the first communication channel, to the computing device.

At 965, the computing device can iteratively compute candidate payload configurations based on the aircraft data and payload data. The pilot application can be programmed to ingest and concatenate the requested aircraft data and payload data to compute a plurality of candidate payload configurations for the aircraft. For example, given the respective payloads of the passengers, the pilot application can be programmed to iteratively generate different combinations of seat assignments and cargo storage assignments within the interior arrangement of the aircraft. In some implementations, the analysis can also take into account the seating preferences and requests from the individual passenger, as described herein.

In an example, the aircraft is a VTOL aircraft. The computing device can access data indicative of a weight and balance constraint for the VTOL aircraft. The computing device can compute a payload configuration for the VTOL aircraft based on the weight and balance constraints for the VTOL aircraft. This can take into account the hover and cruise flight modes of the VTOL aircraft.

At 970, the computing device can compute a selected candidate payload configuration from the candidate payload configurations. For example, the pilot application can continue its iterative processing until a specific combination provides a payload configuration that meets the balance constraints of the aircraft. To the extent more than one candidate payload configuration meets the weight and balance constraints, the pilot application can evaluate how well the candidates meet the seating preferences and travel needs of the passengers, as described herein.

The selected payload configuration can be a payload configuration that is selected by the pilot. For example, the computing device can present a candidate payload configuration to the pilot. To do so, the computing device can output data indicative of the various seating assignments and cargo positions. The data can be visually rendered via a user interface on a display of the user device. The user interface can indicate weights, cargo positions, seating assignments, etc. The pilot may interact with the user interface via a touchscreen or cursor, to adjust the candidate payload configuration by changing a seat assignment or cargo position. The pilot can provide user input to confirm the pilot's approval of the candidate payload configuration. The computing device can flag the confirmed candidate as the selected payload configuration.

The computing device can transmit data indicative of the selected payload configuration to the network system. For example, the computing device can access an API to format a data package that is appropriate for the network system. The data package can indicate the selected payload configuration and can be transmitted to the network system for routing to the appropriate software services (e.g., the aircraft service).

Returning to FIG. 9A, at 930, the computing device can establish a second communication channel with an aircraft computing system. In an example, the second communication channel between the computing device and the aircraft is different than the first communication channel between the computing device and the network system 105. This can allow for asynchronous communication between the computing device/network system and the computing device/aircraft.

FIG. 9C is a flowchart diagram of an example computer-implemented method 975 for establishing a communication channel between a client device and an aircraft according to example embodiments of the present disclosure.

At 980, the computing device can access, from network computing system, aircraft identifier associated with the aircraft. For example, the network system can transmit data indicative of an aircraft identifier for the aircraft assigned to the pilot's upcoming flight. In some implementations, the aircraft identifier can be requested. In some implementations, the aircraft identifier can be pushed, without an explicit request.

At 985, based on the aircraft identifier, the computing device can transmit a signal to request connection with aircraft. The computing device can receive, from the aircraft computing system, data indicative of a connection with the user computing device, at 990. The computing device and the aircraft system can establish the second communication channel in a variety of manners. For example, as described herein, the computing device and the aircraft system can pair with one another via Bluetooth® protocol. Additionally, or alternatively, the computing device and the aircraft system can include wirelessly connecting over a LAN or WiFi network.

Returning to FIG. 9A, at 935, the computing device can access, over the second communication channel and from the aircraft computing system, aircraft data associated with an aircraft. The aircraft data can be acquired pre-flight, inflight, or post-flight. For example, prior to take-off, the computing device can access (e.g., over the second communication channel) data indicative of the aircraft's current charge level, component health and status, location, etc. During flight, the computing device can access updated charge levels, route progress, individual component feedback, altitude, skylane, etc. After landing, the computing device can access similar, updated data in addition to information about the landing (e.g., approach, maneuvers, hover time), overall aircraft flight time, complete route flown, etc.

At 940, based on the aircraft data, the computing device can perform one or more computing functions associated with the aircraft. The computing functions comprise at least one of: one or more of the pre-flight computing functions, one or more computing functions during a flight, or one or more post-flight computing functions. For example, the computing device can utilize the aircraft data from the aircraft system to complete post-flight tasks associated with a post-flight checklist. This can include computing the total flight time for the pilot and the aircraft, checking component status/health, checking charge levels and temperatures to help coordinate downtime charging and cabin cooling, etc.

In some implementations, the pilot application can automatically compute the amount of charging and cooling needed for the aircraft prior to its next flight. This can include identifying a threshold charge level and threshold temperature needed for the next flight as well as the amount of downtime for the aircraft. The pilot application can compute the rate of charging/cooling needed to reach those thresholds prior to the next flight. In some implementations, the pilot application can recommend charging or cooing infrastructure at the aerial facility based on facility data acquired from the aerial facility back-end service. The computing device can present the results of these computations to the pilot (e.g., via a user interface).

At 945, the computing device can transmit, over the first communication channel, the data package to one or more software services of the network computing system. For example, the computing device may compute a data package that is indicative of pilot/aircraft flight times, charge levels, temperatures, component status and health, charging/cooling recommendations, etc. As described herein, this can allow the network system to more readily and efficiently access such information from the aircraft in addition, or in alternative to, communicating with a third party data aggregation service.

### Example Transportation Service

The computing ecosystem of the present disclosure can be implemented to support and manage transportation services. For example, a fleet of aircrafts can perform a transportation service to transport riders to requested destinations. This can include an on-demand transportation service that is provided within a dense urban environment, with shorter flights, and at lower altitudes than those typically provided by commercial airlines. One example of an on-demand transportation service can include a multi-model transportation service. The computing ecosystem described herein can be implemented by the computing systems and devices utilized to provide the multi-modal transportation service.

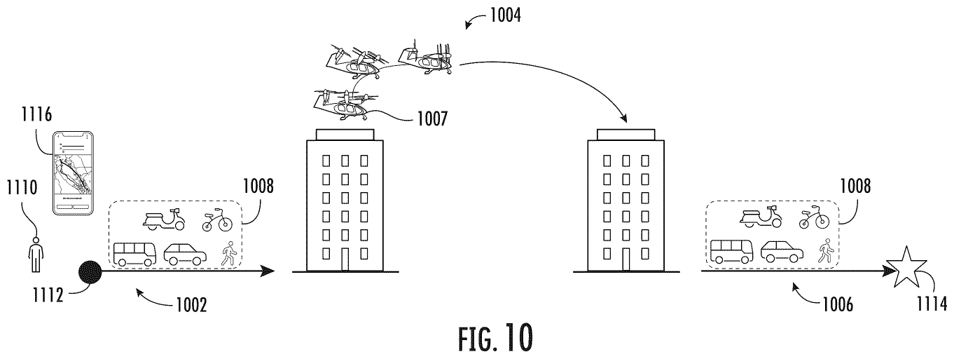

FIG. 10 depicts an example process flow of a multi-modal transportation service according to example implementations of the present disclosure. A multi-modal transportation service can include multiple transportation legs 1002, 1004, 1006 associated with at least two different transportation modalities. For example, the multi-modal transportation service can include a first transportation leg 1002, one or more second transportation legs 1004, and a third transportation leg 1006.

A combination of ground vehicles, aircraft, or other types of vehicles can perform the various legs of the multi-modal transportation service. Each transportation leg of the multi-modal transportation service can be associated with a respective transportation modality. For instance, the first transportation leg 1002 can be associated with a first transportation modality using one or more of ground vehicles 1008 such as an automobile. A second transportation leg 1004 can be associated with a second transportation modality using an air-based modality such as an aircraft 1007. The third transportation leg 1006 can be associated with a third transportation modality, which can be the same or different from the first or second modalities. For example, the third transportation leg 1006 can use a ground modality such as another automobile, bicycle, walking route, etc.

The aerial transport can include one or more different aircrafts such as airplanes, vertical take-off and landing vehicles (“VTOLs”), or other aircraft including conventional take-off and landing vehicles (“CTOLs”). VTOLs, for example, can include one or more different types of rotorcraft (e.g., helicopters, quadcopters, gyrocopters, etc.), tilt-rotor aircraft, powered-lift vehicles, and/or any other vehicle capable of vertically taking-off and/or landing (e.g., without a runway).

As shown in FIG. 10, the aircraft used in the multi-modal transportation service can include a VTOL that is configured to operate in multiple flight modes. For example, an aircraft can include multirotor configurations such that the position, orientation, etc. of the aircraft's rotors can be adjusted to allow the aircraft to operate in the various flight modes. This can include, for example, a first rotor position that allows the aircraft to take-off, land, or hover vertically (e.g., in a hover mode) and a second rotor position that allows the aircraft to travel forward using a thrust force (e.g., in a cruise mode). This can allow the aircraft to take-off and land vertically or perform a conventional take-off and landing.

The aircraft can include one or more types of power sources such as batteries, a combustible fuel source, electrochemical sources (such as a hydrogen fuel cell system), or a combination thereof. For example, the aircraft can include electric VTOLs (“eVTOLs”) capable of operating using one or more electric batteries, VTOLs capable of operating using combustible fuel, or VTOLs using hybrid propulsion systems.

The multi-modal transportation service can be provided in an on-demand manner. The service can include a ridesharing, ride-hailing, vehicle reservation, or delivery service. The multi-modal transportation service can be coordinated for a user 1110 by one or more service providers.

A service provider can be an entity that offers, coordinates, manages, etc. a transportation service. This can include a transportation network company, vehicle fleet manager, etc. For example, a user 1110 may desire to travel on a journey from an origin location 1112 to a destination location 1114. The user 1110 can interact with a user device 1116, via a user interface of a software application, to book transportation for the journey. The user 1110 can interact with user device 1116 over one or more user sessions.

Based on the user sessions, at least one service entity can compile one or more options for the user 1110 to traverse the journey. The user device 1116 of the user 1110 may present these options to the user 1110 via a user interface of the software application. At least one option for the journey can include the multi-modal transportation service. Responsive to selection of the multi-modal transportation service option by the user 1110, the service can be initiated for transportation for user 1110.

To track and coordinate the multi-modal transportation service, a passenger itinerary can be computed for the user 1110. A passenger itinerary (also referred to as a “multi-modal itinerary”) can be defined by a data structure that includes various information associated with a user's trip from an origin location to a destination location. As described herein, passenger itinerary can refer to the passenger itinerary or the underlying data structure depending on the context. As described herein, the passenger itinerary may include: identifiers for locations of interest (e.g., names/coordinates for origins, destinations, vertiports, etc.), times/durations the user is at each location, transportation modalities, specific vehicle assignments, seat assignments, real-time location data, luggage information, or other information. The passenger itinerary can be updated in real-time as the user 1110 progresses along the journey, in response to any changes to the journey, etc. The passenger itinerary can be available to the user 1110 via the user device 1116.

Building passenger itineraries on-demand across modalities can involve centralized or distributed scheduling of resources associated with each modality. For instance, example implementations can involve systems and devices that interface with user 1110, systems and devices associated with a first modality of transportation, and systems and devices associated with a second modality of transportation.

The itinerary of the user 1110 can be based on the user's origin location, destination location, available intermediate locations for transitioning between transportation modalities, vehicle routes, and/or other information.

The computing ecosystem described herein can facilitate the transportation service for the user 1110 in a variety of manners. For example, the computing functions performed on the user device 115 of the pilot can provide information to the network system 105 that allows the network system 105 to quickly identify and diagnose any potential delays or disruptions. This can allow the network system 105 to more readily compute an adjustment to a passenger itinerary such that the user's ultimate ETA at the destination location 1114 is not violated. Accordingly, substantial processing resources can be saved by proactively making adjustments, which can avoid a cascading effect of changes across a high number of passenger that requires significant compute power.

By way of example, the results of the automatic weight and balance computation may indicate that a cargo item of user 1110 (e.g., their baggage) cannot be transported on the aircraft 1007 due to its weight. In response, the network system can adjust the passenger's itinerary to assign the user 1110 to another flight. This can be accomplished by revising the entry in a data field of the data structure that stores the passenger itinerary. The user 1110 can be assigned to another flight with little to no impact on other passengers.

Additionally, or alternatively, the network system 105 can communicate with a third-party ground transportation provider to have the cargo driven to the user's final destination (if acceptable to the passenger). This can allow the user 1110 to remain on the flight and avoid delays to other passengers as well.

In another example, the pre-flight or post-flight computing functions performed by the user device 115 may indicate that the aircraft 1007 needs additional charging or cooling. Accordingly, the take-off time for the aircraft may be delayed. In response, the network system 105 can perform one or more mitigation actions to avoid negatively impacting passengers'ETAs. For example, the network system 105 (e.g., the flight operations service 225) can adjust the route or skylane of the aircraft 1007 to reduce flight duration. Additionally, or alternatively, the network system 105 can communicate with a third party ground transportation provider to prioritize the passengers of the delayed flight.

### Example Computing System Components

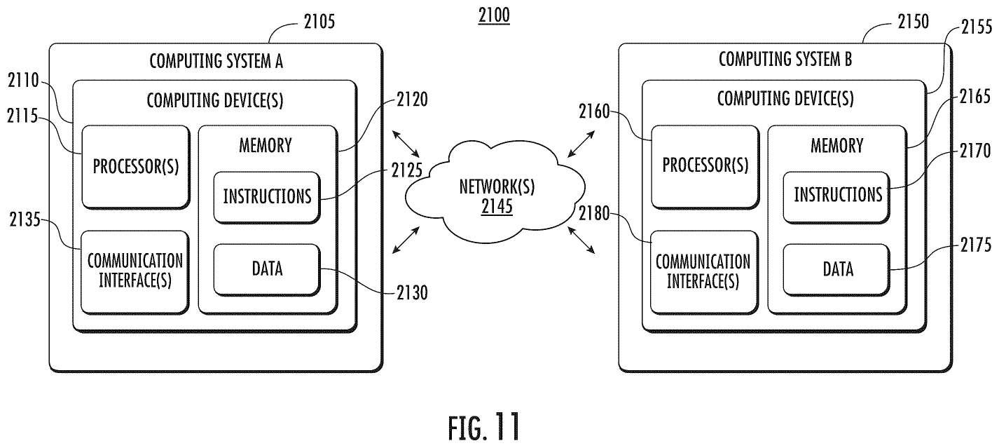

FIG. 11 depicts example system components of an example system 2100 according to example implementations of the present disclosure. The example system 2100 can include a computing system 2105 and a computing system 2150 that are communicatively coupled over one or more networks 2145. The computing systems 2105 and 2150 can represent, for example, computing systems/devices that are onboard or offboard an aircraft, a cloud computing system, user computing devices, or other systems/devices described herein.

The computing system 2105 can include one or more computing devices 2110. The computing devices 2110 of the computing system 2105 can include one or more processors 2115 and a memory 2120. The processors 2115 can be any suitable processing device (e.g., a processor core, a microprocessor, an ASIC, a FPGA, a controller, a microcontroller, etc.) and can be one processor or a plurality of processors that are operatively connected. The memory 2120 can include one or more non-transitory computer-readable storage media, such as RAM, ROM, EEPROM, EPROM, one or more memory devices, flash memory devices, etc., and combinations thereof.

The memory 2120 can store information that can be accessed by the processors 2115. For instance, the memory 2120 (e.g., one or more non-transitory computer-readable storage mediums, memory devices) can include computer-readable instructions 2125 that can be executed by the processors 2115. The instructions 2125 can be software written in any suitable programming language or can be implemented in hardware. Additionally, or alternatively, the instructions 2125 can be executed in logically and/or virtually separate threads on processors 2115.

For example, the memory 2120 can store instructions 2125 that when executed by the processors 2115 cause the processors 2115 to perform operations such as any of the processes/methods described herein or any of the operations and functions of any of the computing systems (e.g., network system, aircraft system, third party system, etc.) and/or computing devices (e.g., user device, passenger device, etc.), as described herein.

The memory 2120 can store data 2130 that can be obtained, received, accessed, written, manipulated, created, and/or stored. The data 2130 can include, for instance, any of the data/information described herein. In some implementations, the computing devices 2110 can obtain from and/or store data in one or more memory devices that are remote from the computing system 2105 such as one or more memory devices of the computing system 2150.

The computing devices 2110 can also include a communication interface 2135 used to communicate with one or more other systems (e.g., computing system 2150). The communication interface 2135 can include any circuits, components, software, etc. for communicating via one or more networks (e.g., 2145). In some implementations, the communication interface 2135 can include for example, one or more of a communications controller, receiver, transceiver, transmitter, port, conductors, software and/or hardware for communicating data/information.

The computing system 2150 can include one or more computing devices 2155. The computing devices 2155 can include one or more processors 2160 and a memory 2165. The one or more processors 2160 can be any suitable processing device (e.g., a processor core, a microprocessor, an ASIC, a FPGA, a controller, a microcontroller, etc.) and can be one processor or a plurality of processors that are operatively connected. The memory 2165 can include one or more non-transitory computer-readable storage media, such as RAM, ROM, EEPROM, EPROM, one or more memory devices, flash memory devices, etc., and combinations thereof.

The memory 2165 can store information that can be accessed by the processors 2160. For instance, the memory 2165 (e.g., one or more non-transitory computer-readable storage mediums, memory devices) can store data 2175 that can be accessed (e.g., obtained, received, written, manipulated, created, stored, pulled, etc.). The data 2175 can include, for instance, any data or information described herein. In some implementations, the computing system 2150 can obtain data from one or more memory devices that are remote from the computing system 2150.

The memory 2165 can also store computer-readable instructions 2170 that can be executed by the processors 2160. The instructions 2170 can be software written in any suitable programming language or can be implemented in hardware. Additionally, or alternatively, the instructions 2170 can be executed in logically and/or virtually separate threads on processors 2160. For example, the memory 2165 can store instructions 2170 that when executed by the processors 2160 cause the processors 2160 to perform any of the operations and/or functions described herein, including, for example, any of the processes/methods described herein or the operations and functions of any of the computing systems (e.g., network system, aircraft system, third party system) or computing devices (e.g., user device, passenger device), as described herein.

The computing devices 2155 can also include a communication interface 2180 used to communicate with one or more other systems. The communication interface 2180 can include any circuits, components, software, etc. for communicating via one or more networks (e.g., 2145). In some implementations, the communication interface 2180 can include for example, one or more of a communications controller, receiver, transceiver, transmitter, port, conductors, software and/or hardware for communicating data/information.

The networks 2145 can be any type of network or combination of networks that allows for communication between devices. In some implementations, the networks 2145 can include one or more of a local area network, wide area network, the Internet, secure network, cellular network, mesh network, peer-to-peer communication link and/or some combination thereof and can include any number of wired or wireless links. Communication over the networks 2145 can be accomplished, for instance, via a network interface using any type of protocol, protection scheme, encoding, format, packaging, etc.

FIG. 14 illustrates one example system 2100 that can be used to implement the present disclosure. Other computing systems can be used as well. Computing tasks discussed herein as being performed at computing devices remote from a vehicle/device can instead be performed at the vehicle/device, or vice versa. Such configurations can be implemented without deviating from the scope of the present disclosure.

### Additional Disclosure

The use of computer-based systems allows for a great variety of possible configurations, combinations, and divisions of tasks and functionality between and among components. Computer-implemented operations can be performed on a single component or across multiple components. Computer-implemented tasks and/or operations can be performed sequentially or in parallel. Data and instructions can be stored in a single memory device or across multiple memory devices.

Aspects of the disclosure have been described in terms of illustrative implementations thereof. Numerous other implementations, modifications, or variations within the scope and spirit of the appended claims can occur to persons of ordinary skill in the art from a review of this disclosure. Any and all features in the following claims can be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. For example, operations described as being performed by a certain system/device, can instead be performed by another system/device described herein.

Moreover, terms are described herein using lists of example elements joined by conjunctions such as “and,” “or,” “but,” etc. It should be understood that such conjunctions are provided for explanatory purposes only. Lists joined by a particular conjunction such as “or,” for example, can refer to “at least one of” or “any combination of” example elements listed therein. The term “or” should be understood as “and/or” unless otherwise indicated. Also, terms such as “based on” should be understood as “based at least in part on.”

Those of ordinary skill in the art, using the disclosures provided herein, will understand that the elements of any of the claims, operations, or processes discussed herein can be adapted, rearranged, expanded, omitted, combined, or modified in various ways without deviating from the scope of the present disclosure. At times, elements can be listed in the specification or claims using a letter reference for exemplary illustrated purposes and is not meant to be limiting. Letter references, if used, do not imply a particular order of operations or a particular importance of the listed elements. For instance, letter identifiers such as (a), (b), (c), . . . , (i), (ii), (iii), . . . , etc. may be used to illustrate operations or different elements in a list. Such identifiers are provided for the ease of the reader and do not denote a particular order, importance, or priority of steps, operations, or elements. For instance, an operation illustrated by a list identifier of (a), (i), etc. can be performed before, after, or in parallel with another operation illustrated by a list identifier of (b), (ii), etc.

What is claimed is:

1. A system comprising:
a network computing system comprising a plurality of software services associated with aircraft operations; and
a user computing device operable to connect to the network computing system, over a network, to access data from one or more software services of the plurality of software services,
wherein the user computing device is operable to automatically perform one or more pre-flight computing functions for an aircraft based on the data from the one or more software services of the network computing system, and
wherein at least one of the pre-flight computing functions comprises an automatic weight and balance computation for a payload of the aircraft based on the data accessed from the one or more software services of the network computing system.

2. The system of claim 1, wherein the data from the one or more software services comprises aircraft data and payload data,
wherein the aircraft data is indicative of: (ii) a seat and cargo configuration of the aircraft, and (ii) a payload capacity of the aircraft, and
wherein the payload comprises a plurality of individual payload items, and wherein the payload data is indicative of at least one of: (i) a weight for each respective payload item or (ii) dimensions for each respective payload item.

3. The system of claim 2, wherein to perform the automatic weight and balance computation for the payload of the aircraft:
the user computing device is operable to process the aircraft data and the payload data to compute a payload configuration, the payload configuration defining a position of each respective payload item within the seat and cargo configuration of the aircraft based on: the payload capacity of the aircraft, and at least one of the weight or the dimensions for each respective payload item, and
the user computing device is operable to output data indicative of the payload configuration for presentation via a user interface of the user device.

4. The system of claim 3, wherein to compute the payload configuration, the user computing device is operable to process the seat and cargo configuration and the payload data to iteratively compute candidate payload configurations, and
wherein the user computing device is operable to compute a selected payload configuration from the candidate payload configurations, the selected payload configuration being within weight and balance constraints of the aircraft.

5. The system of claim 2, wherein the aircraft data is indicative of: a charge level of the aircraft, and wherein the payload configuration is further based on the charge level of the aircraft.

6. The system of claim 3, wherein the user computing device is operable to transmit, over the network, the data indicative of the payload configuration to the network computing system.

7. The system of claim 1, further comprising:
an aircraft computing system of the aircraft,
wherein the user computing device is operable to connect with the aircraft computing system of the aircraft.

8. The system of claim 7, wherein the user computing device is operable to access data indicative of an aircraft identifier from the network computing system and connect with the aircraft computing system based on the aircraft identifier.

9. The system of claim 7, wherein to connect with the network computing system the user computing device is operable to establish a first communication channel with the network computing system, and wherein to connect with the aircraft computing system the user computing device is operable to establish a second communication channel with the aircraft computing system that is separate from the first communication channel.

10. The system of claim 9, wherein the second communication channel between the user computing device and the aircraft computing system is maintained while the aircraft is in-flight from an origin to a destination, and wherein the first communication channel is disconnected for a least a time period while the aircraft is in-flight from the origin to the destination and the first communication channel is reestablished when the aircraft lands at the destination.

11. The system of claim 10, wherein the user computing device is operable to transmit an updated data package to the network computing system after the first communication channel is reestablished, the updated data package comprising at least one of: (i) pilot flight time data, or (ii) aircraft performance data.

12. The system of claim 1, wherein the user computing device is operable to automatically perform one or more post-flight computing functions for the aircraft.

13. The system of claim 1, wherein the network computing system comprises a micro-service architecture, and the plurality of software services comprise a plurality of micro-services.

14. The system of claim 1, wherein the plurality of software services comprise at least one of: (i) a pilot software service, (ii) an aircraft software service, (iii) a passenger software service, (iv) an aerial facility software service, (v) a flight operations software service, or (vi) an aircraft maintenance software service.

15. The system of claim 1, wherein the user computing device comprises a software application, the software application comprising a login interface for a pilot of the aircraft, and wherein the user computing device is operable to perform a handshake with the network computing system to establish a communication channel between the network computing system and the user device.

16. A user device comprising:
one or more processors; and
one or more memories that store instructions that are executable by the one or more processors to perform operations comprising:
launching a software application;
accessing, via the software applications, credentials from a pilot;
establishing a first communication channel with a network computing system based on the credentials, wherein the network computing system comprises a plurality of software services associated with aircraft operations;
accessing, over the first communication channel, data from one or more software services of the network system;
performing one or more pre-flight computing functions based on the data from the one or more software services of the network computing system, and
wherein at least one of the pre-flight computing functions comprises an automatic weight and balance computation for a payload of an aircraft based on the data accessed from the one or more software services of the network computing system.

17. The user device of claim 16, wherein the operations further comprise:
establishing a second communication channel with an aircraft computing system;
accessing, over the second communication channel and from the aircraft computing system, aircraft data associated the aircraft; and
based on the aircraft data, performing one or more computing functions associated with the aircraft, wherein the computing functions comprise at least one of: one or more of the pre-flight computing functions, one or more computing functions during a flight, or one or more post-flight computing functions.

18. The user device of claim 16, wherein accessing the data from the one or more software services of the network computing system comprises:
accessing an API associated with the network computing system;
computing a request for the data from the one or more software services based on the API, the request comprising one or more queries for the data from the one or more software services; and
transmitting, over the first communication channel, the request for the data from the one or more software services.

19. The user device of claim 16, wherein the plurality of software services comprises at least one of: (i) a pilot software service, (ii) an aircraft software service, (iii) a passenger software service, (iv) an aerial facility software service, (v) a flight operations software service, or (vi) an aircraft maintenance software service.

20. A computer-implemented method comprising:
launching a software application;
accessing, via the software applications, credentials from a pilot;
establishing a first communication channel with a network computing system based on the credentials, wherein the network computing system comprises a plurality of software services associated with aircraft operations;
accessing, over the first communication channel, data from one or more software services of the network system;
performing one or more computing functions for an aircraft based on the data from the one or more software services of the network computing system, and
wherein at least one of the pre-flight computing functions comprises an automatic weight and balance computation for a payload of the aircraft based on the data accessed from the one or more software services of the network computing system.
